(19) United States
(12) Patent Application Publication
(10) Pub. No.: US 2017/0152337 A1
(43) Pub. Date: Jun. 1, 2017

(54) UNSATURATED POLYESTER RESIN SYSTEMS WITH LATENT THICKENING TENDENCIES

(71) Applicant: BYK-Chemie, GmbH, Wesel (DE)

(72) Inventors: Frederik PIESTERT, Wesel (DE); Wolfgang PRITSCHINS, Wesel (DE); Sascha KOCKOTH, Stuttgart (DE); Jürgen OMEIS, Dorsten-Lembeck (DE)

(21) Appl. No.: 15/320,556

(22) PCT Filed: Jun. 23, 2015
(86) PCT No.: PCT/EP2015/064152

§ 371 Date: Dec. 20, 2016

(30) Foreign Application Priority Data
Jun. 24, 2014 (EP) 14173761.9

(51) Int. Cl. C08F 283/01; C08K 3/36; C08K 9/04; C08K 3/34

(52) U.S. Cl. CPC C08F 283/01; C08K 3/34; C08K 3/36; C08K 9/04

(57) ABSTRACT

The invention relates to a two- or multi-component system having: at least one polyester component 1 which comprises: i) at least one unsaturated polyester; ii) at least one ethylenically unsaturated monomer; iii) at least one inorganic thickener (a1); and iv) at least one wetting- and dispersing agent (a2) that inhibits the thickening action of the inorganic thickener (a1); and at least one initiator component 2 which i) comprises at least one component (b1) that is able to at least partly neutralise the inhibition of the thickening action of the inorganic thickener (a1) and ii) at least one initiator that is able to trigger the polymerisation of components (i) and (ii) of the polyester component 1. The wetting- and dispersing agent (a2) is non-reactive in relation to components (i) and (ii) of the polyester component 1. The invention also relates to substrates coated with a two- or multi-component system according to the invention. The invention further relates to the use of a combination of (a1) and (a2) in formulations containing unsaturated polyesters, in order to provide said formulations with a latent thickening effect.

The present invention relates to unsaturated polyester resin systems (UP systems) which are obtained using latent thickeners. The systems are two-component or multicomponent systems, more particularly adhesives, sealants, coating materials or molding compounds. In the field of art of unsaturated polyesters, the term “unsaturated” stands for substances which contain carbon-carbon double bonds.

Particularly within the field of adhesives, sealants, coatings materials, and molding compounds it is necessary to tailor the rheological properties of such systems. Consistency is adjusted primarily through the selection of binders, solvents, and the amount of pigments and/or fillers. In many cases, however, adjusting the desired consistency by means of the aforementioned constituents is not enough. In such cases, additives known as rheological additives must be added. Their effect may be a decrease in viscosity for better processing qualities, or an increase in viscosity, also referred to in the context of the present invention as thickener.

For the stated applications, a multitude of different organic or inorganic thickeners are described.

Employed primarily in aqueous systems in this context are cellulose ethers, starch, natural hydrocolloids, synthetic biopolymers, polyacrylate thickeners, associative thickeners based on hydrophobically modified polymers such as polyethers, etherurethanes, polyacrylamides, and alkali-activated acrylate emulsions, or water-swellable inorganic thickeners.

Typical rheological additives for nonaqueous systems, besides organic thickeners such as waxes and thixotropic resins, are inorganic thickeners such as, for example, magnesium oxide and magnesium hydroxide, which are used primarily in unsaturated polyester resin systems, or amorphous silicas and phyllosilicates.

A feature common to all of the aforesaid inorganic thickeners, however, is that in the aqueous, and more particularly nonaqueous systems, that are to be thickened, they develop their viscosity-increasing effect directly after incorporation and/or mixing. This is a disadvantage particularly in two-component or multicomponent systems.

Two-component systems in the narrower sense are those systems in which a chemical reaction which leads to curing is initiated by mixing two components, in the ratio required for curing. The individual components here are usually themselves not coating materials, adhesives, sealants or molding compounds, since either they are incapable of crosslinking and/or film-forming or they do not produce stable films, adhesive bonds or moldings. The mixture of the components must be processed within a defined time (pot life or working time), since the processing properties deterioriate increasingly when this time has expired. Such two-component systems are used in particular when there are especially exacting requirements in terms of the temperature sensitivity of the article to be coated and/or the article size is unusually large (facings, machines, rotor blades of wind turbines, etc.), or in terms of resistance to mechanical, chemical, and climatic exposures with rapid curing at room temperature (23° C.) or less, or slightly elevated temperatures (up to 100° C. for example). In the present invention, two-component or multicomponent systems are understood to be systems which are produced by mixing before use at least two components initially stored separately, and which cure after being mixed. Three- or multicomponent systems differ from two-component systems only in that one or more further components are added to the mixture, and in the case of chemical curing are able to participate in the chemical reaction or initiate it, or else possess a different function.

In the case of two- or multicomponent systems, each of the components is stored separately and only when needed the preferably reactive mixture of the components is produced.

With conventional two- or multicomponent mixtures, the viscosity of each of the components must first be adjusted separately, with the aim being to avoid large differences in viscosity. The viscosity of the individual components here is typically relatively high already, having the effect of making them more difficult to transport, and also to process or mix homogeneously.

Particular significance therefore attaches to setting an initially very low viscosity of the individual components of two- or multicomponent systems.

Especially in the adhesives sector, the challenge arises of adjusting the resin component and the curing component initially in each case to a very low viscosity, in order to ensure optimum and homogeneous miscibility of the components with one another. Alternatively, during and/or preferably after the mixing of the components, a sag-resistant consistency, which prevents the mixture simply running, ought to be established as rapidly as possibly. Only in this way it is possible for a finished adhesive mixture to be applied in film thicknesses of several millimeters to centimeters on substrates to be bonded. Exacting requirements are imposed in this respect particularly with substrates requiring large-surface-area bonding, such as the rotor blade halves of wind turbines, for example.

As described in EP 281 124 A2, the rapid attainment of a sag-resistant, meaning a high-viscosity, consistency is achieved frequently by dispersing a thixotropic agent into the resin, such as a hydrophilic fumed silica, for example. The curing agent is subsequently admixed. Subject to the proviso that a sufficient amount of thixotropic agent is added, the mixtures retain their consistency prior to geling and curing.

A disadvantage of the aforementioned system is that systems filled with fumed silica, such as the starting resin mixture used prior to mixing, customarily have a high viscosity. There are therefore great limits on the amount of fumed silica that can be used. Another disadvantage of many systems of this kind, moreover, is that under the influence of mechanical stress or heat, before geling of the system occurs, the sag resistance is lost and in certain cases is never regained either. The reason for this is probably that the internal network of hydrogen bonds between the silica particles, which is responsible for the thickening effect, undergoes at least partial collapse.

One approach to preventing the collapse of such networks and therefore to retaining the sag resistance is to reinforce the network. This is accomplished for example by addition of a high molecular mass polyethyleneimine having a weight-average molar mass of about 750 000 g/mol, as described in EP 0 835 910 A1.

Also known are rheological additives based on polyhydroxycarboxamides, which in combination with fumed silica, in solventborne systems, enhance the incorporation of the silica and increase and stabilize the thixotropic behavior. Such products are, for example, also used in the compositions comprising fumed silica that are described in WO 2010/147690 A2, in tandem with a dispersant (Disperbyk-161), in order to improve the leveling of paints.

There is, however, a need in particular for UP resin systems which comprise inorganic thickeners whose viscosity-increasing property in the system in question is suppressed, in other words inhibited, until this property is required. Since UP resin systems in particular usually include only very small fractions, or none at all, of volatile organic solvents, their rheological adjustment is particularly difficult.

A chemical path for solving these problems is set out, in the sector of industrial adhesives for the bonding of rotor blade halves, for example, by Eva Bittmann in the article “Viet Wind um GFK. Werkstoffe and Verfahren im Rotorblattbau”, Kunststoffe 92 (11) (2002) pages 119-124. In this article, the use is described of a variety of resin systems, such as, for example, the use of epoxy resins, vinyl ester resins or unsaturated polyester resins, for the bonding of rotor blade components. It is noted that for the bonding of shells and webs, thick adhesive seams are required, where the material must not run on sloping surfaces, meaning that highly thixotroped systems are to be employed. In accordance with the aforesaid article, the company Vantico developed a chemical thixotroping of epoxy resin adhesives, not described in any more detail, which takes place only when resin and curing agent are mixed, thereby allowing easy transport of the low-viscosity starting components and high sag resistance on the part of the mixture.

Also used in the area of aqueous systems, for example, are organic thickeners based on homo-, co-, and terpolymers of acrylic acid and methacrylic acid, which exhibit no thickening effect for as long as their carboxylic acid groups are protonated. Only by means of at least partial neutralization high-viscosity solutions are formed through the formation of gel structures in the water phase via hydrogen bonds, association of water molecules along the polymer chains, and intramolecular repulsion and uncoiling through formation of the carboxyl groups. Polymeric thickeners of this kind are not, however, used in nonaqueous systems.

There is therefore still a great desire to provide UP resin systems which comprise latent-thickening inorganic thickeners, which accordingly develop their thickening effect, even in nonaqueous systems, only when this effect is desired.

It would be particularly advantageous for the use of an inorganic thickener, in adhesives or sealants, for example, to be able at the same time to increase the binding force of the cured adhesive or sealant and thus to increase the mechanical stability of the adhesive bond. This is useful in particular where bonds are used under high mechanical stress, as in the case of adhesive bonds of rotor blades, for example, which are consequently able to accommodate greater mechanical energy.

To date there has been no UP resin system available based on latent inorganic thickeners that meets the requirements addressed above.

An object of the present invention, therefore, was to provide UP resin systems which are preferably adhesives, sealants, coating materials or molding compounds. Such two-component or multicomponent systems are to be capable, after mixing of the components, especially of the resin component on the one hand and the initiator/accelerator component on the other, to develop the thickening effect which initially is present only in latent form. In particular the thickeners ought also to be capable of enhancing the mechanical properties of the cured two- or multicomponent systems, and especially of increasing their stability.

The above objects can be achieved through provision of a two- or multicomponent system comprising at least one polyester component 1 which comprises
i. at least one unsaturated polyester,
ii. at least one ethylenically unsaturated monomer,
iii. at least one inorganic thickener (a1), and
iv. at least one wetting and dispersing agent (a2) which inhibits the thickening effect of the inorganic thickener (a1);
   and
      at least one initiator component 2 which comprises
i. at least one component (b1) which is able at least partly to eliminate the inhibition of the thickening effect of the inorganic thickener (a1), and
ii. at least one initiator which is able to trigger the polymerization of components i. and ii. of the polyester component 1; and
the wetting and dispersing agent (a2) being nonreactive toward components i. and ii. of the polyester component 1.

The polyester component 1 and the initiator component 2 represent two spatially separate individual components which are in a functional unit through a goal-directed use (“Kit-of-Parts”). In the present case, the goal-directed common use of the initially spatially separate components is to equip the two- or multicomponent system with the latent thickening property. This means that an increase in viscosity takes place after mixing of components 1 and 2 and, optionally, of further components of the two- or multicomponent systems.

The condition to the effect that the wetting and dispersing agent (a2) is not reactive toward the at least one unsaturated polyester is understood by a person of ordinary skill in the present art to mean that under the customary storage conditions, the wetting and dispersing agents (a2) behave preferably very largely inertly toward the unsaturated polyester. An inert behavior is understood more particularly as a chemically inert behavior. This means that the polyester component 1 is preferably very largely storage-stable. The storage stability may be ascertained for example by way of the constancy of the viscosity of the stored polyester component 1. The viscosity of the polyester component 1 is to change insubstantially, if at all, preferably even over a prolonged storage period. Such possible, albeit unwanted, increases in viscosity are, however, not brought about by the effect according to the invention, since not all of the additives needed are present at the same time, being instead present spatially separately in the different base components (polyester component 1 and initiator component 2). In any case it is preferred for no reaction between the unsaturated polyester of the polyester component 1 and the wetting and dispersing agent (a2) to take place between incorporation of the wetting and dispersing agent (a2) into the unsaturated polyester of the polyester component 1, and the mixing of the polyester component 1 with the initiator component 2.

Unsaturated polyesters are preferably linear, preferably soluble polycondensation products of unsaturated dicarboxylic acids, such as maleic and/or fumaric acid, with dihydric alcohols, where a portion of the alpha,gamma-unsaturated dicarboxylic acids is frequently replaced by saturated or aromatically unsaturated dicarboxylic acids. In an extended sense, the term “unsaturated polyester resins” (UP resins) embraces solutions of unsaturated polyesters in a monomer capable of copolymerization, usually styrene. The crosslinking principle of an unsaturated polyester resin is that the preferably linear unsaturated polyesters, which contain double bonds, are joined to one another—that is, crosslinked—by monomeric, polymerizable compounds (such as styrene, for example). This linking which occurs in the presence of polymerization initiators is a copolymerization or—as has also been proposed—a composite polymerization or crosslinked graft polymerization. The general curing conditions, and the ratio used of the unsaturated polyester to the ethylenically unsaturated monomer, determine whether the linkage takes place through a single unit of the ethylenically unsaturated monomer, preferably styrene, or through a chain of these monomers (see Kittel, “Lehrbuch der Lacke and Beschichtungen”, vol. 2, second edition, 1998, pp. 473-485).

The two components, ethylenically unsaturated monomer and unsaturated polyester, react by addition of an initiator. In the case of conventional curing (crosslinking), suitable polymerization initiators are preferably peroxides and hydroperoxides. Where peroxides or hydroperoxides are used as initiators in the initiator component 2, the polyester component 1 customarily includes what is called an accelerator, whose effect is to cause these initiators to undergo decomposition to form radicals. Suitable initiators are organic metal compounds or tertiary aromatic amines. As initiator in the initiator component 2, however, it is also possible for there to be a photoinitiator present, preferably a photoinitiator of the benzoin or benzil type. In such a case there is no need for accelerator in the polyester component 1, since radical formation is initiated preferably by UV rays (Kittel, ibid).

The two- and multicomponent systems of the invention are preferably nonaqueous two- or multicomponent systems which with particular preference are free from volatile organic solvents or substantially free from volatile organic solvents.

For the purposes of the invention, systems referred to as nonaqueous are those which are substantially water-free, meaning preferably those which contain less than 10 wt %, more preferably less than 8 wt %, very preferably less than 5 wt % of water, based on the overall composition of the system.

Substantially free from volatile organic solvents means that there are preferably less than 15 wt %, more preferably less than 10 wt %, very preferably less than 5 wt % of volatile organic solvents present, based on the total weight of the two-component or multicomponent system of the invention, of volatile organic solvents in the two- or multicomponent system of the invention.

### Polyester Component 1

### Unsaturated Polyesters

The unsaturated polyester is preparable generally by the methods commonplace for the alkyd resins. Significance has been acquired in particular by azeotropic esterification, as a variant of melt condensation for particularly sensitive starting materials. As entrainer for water resulting from the reaction it is possible to make use, for example, of toluene or xylene. Since the monomers used, in particular at least a portion of the dicarboxylic acids, are unsaturated, the reaction must be carried out in the absence of atmospheric oxygen, preferably in an inert gas atmosphere, in order not to trigger premature polymerization. As far as possible the esterification temperatures ought not to exceed 150 to 200° C. The progress of polymerization may be monitored by determination of the acid number and viscosity. Generally, moreover, the hot melt is mixed with the ethylenically unsaturated monomer, which with particular preference is styrene. So that premature polymerization does not occur here, it is preferred to add inhibitors—such as, for example, toluhydroquinone, hydroquinone or tert-butylcatechol (Kittel, ibid)—to the ethylenically unsaturated monomer, and where appropriate also to the melt of the unsaturated polyester.

The polymerizable carbon-carbon double bonds which are necessarily present in the unsaturated polyesters may be present in principle in the dicarboxylic acid component or in the diol component or in both. Technical importance, however, has been obtained only by those unsaturated polyester resins in which the polymerizable carbon-carbon double bond is present in the dicarboxylic acids.

Unsaturated dicarboxylic acids used for preparing the unsaturated polyesters are preferably maleic acid and fumaric acid, with maleic acid being used more particularly in the form of maleic anhydride. Maleic acid and maleic anhydride is the most economically favorable unsaturated dicarboxylic acid. In comparison to maleic acid, fumaric acid leads to products having greater mechanical strength and chemical resistance, and is also more reactive than maleic acid. Less commonplace, though in principle able to be used as unsaturated dicarboxylic acids, for example, are also mesaconic acid, citraconic acid, and itaconic acid.

Since unsaturated polyesters having a very high level of carbon-carbon double bonds yield highly crosslinked end products which are therefore relatively brittle, after the polymerization, it is usual to use not only unsaturated dicarboxylic acids for preparing the unsaturated polyesters, but also aliphatic or cycloaliphatic dicarboxylic acids and/or aromatic dicarboxylic acids.

An example of an aliphatic dicarboxylic acid contemplated is adipic acid, which typically gives the polymerized unsaturated polyester resins a higher flexibility. The cycloaliphatic tetrahydrophthalic acid, in contrast, usually endows films produced from the unsaturated polyester resins with a greater hardness. For certain applications in the field of thermoset plastics, it is also possible for tetrachlorinated or tetrabrominated phthalic acid and/or its anhydride to be used.

Aromatic dicarboxylic acids used are, in particular, phthalic acid and/or its anhydride, affording cured polyesters having good elasticity. Other aromatic dicarboxylic acids which can be used are, for example, isophthalic acid and terephthalic acid, especially when producing thermoset plastics.

Employed as alcohol component almost exclusively are diols, since alcohols of higher functionality, such as triols, for example, already give branched unsaturated polyesters which are therefore highly viscous. Preference is therefore given to using exclusively diols when preparing unsaturated polyester resins.

Preference for use as diols is given to those selected from the group consisting of 1,2-propanediol, 1,3-propanediol, ethylene glycol, diethylene glycol, dipropylene glycol, triethylene glycol, neopentyl glycol, 2-methyl-2-ethylpropane-1,3-diol, hydrogenated bisphenol A, or oxalkylated bisphenols.

In order to overcome the oxygen inhibition in the polymerization process of customary unsaturated polyester resin, it is also possible for monoallyl and diallyl ethers of glycerol and trimethylolpropane and/or diallyl and triallyl ethers of pentaerythritol to be incorporated into the unsaturated polyester.

### Ethylenically Unsaturated Monomers

The term ethylenically unsaturated monomers refers in the art to those monomers which contain a carbon-carbon double bond. This carbon-carbon double bond can be present in a vinyl group, an allyl group, an acrylate group, methacrylate group, or a nonterminal region of the monomer for example. The ethylenically unsaturated monomers ought preferably to possess a low vapor pressure, be able to dissolve the unsaturated polyester resin, produce a low viscosity in the solution, and possess good capacity for copolymerization with the unsaturated polyester.

Particularly preferred ethylenically unsaturated monomers can be selected from the group consisting of styrene, alpha-methylstyrene, methyl acrylate, methyl methacrylate, vinyl acetate, divinylbenzene, diallyl phthalate, triallyl cyanurate, and triallyl phosphate.

### Especially Preferred is Styrene.

The fraction of the ethylenically unsaturated monomer, based on the sum of the weight of unsaturated polyester and ethylenically unsaturated monomer, is customarily 20 to 50 wt %, more preferably 25 to 40 wt %.

Other ethylenically unsaturated monomers and unsaturated polyesters suitable for the two- or multicomponent systems of the invention are disclosed on an exemplary basis in patent specifications EP2447293B1 or EP2411441B1, for example.

### Inorganic Thickeners (a1)

The inorganic thickener (a1) is selected preferably from the group consisting of phyllosilicates and amorphous silicas, more preferably phyllosilicates and precipitated or fumed silicas. Precipitated silicas are obtained wet-chemically by precipitation, while fumed silicas are obtained by continuous flame hydrolysis.

Among the inorganic thickeners, phyllosilicates and fumed silicas are preferred in particular. In contrast to the wet-chemically obtained silicas (precipitated silicas), which usually possess very high internal surface areas, silicas obtained by flame hydrolysis consist of virtually spherical primary particles having particle diameters of typically 7 to 40 nm. They have essentially only an outer surface. This surface is partly occupied by silanol groups. The high fraction of free silanol groups gives untreated fumed silica a hydrophilic character. It is also possible, however, though more costly, to subject the originally hydrophilic surface of fumed silicas to organic aftertreatment, with dimethyldichlorosilane, trimethoxyoctylsilane or hexamethyldisilazane, for example, in which case the majority of the silanol groups are saturated with organic groups and hence the hydrophilic silica is rendered hydrophobic. The fumed silicas can therefore be present in the form of non-organically modified fumed silicas or of hydrophobically modified fumed silicas, the non-organically modified fumed silicas being particularly preferred.

Among the phyllosilicates, particular preference is given to clay materials, and particular preference in turn to the organically modified clay materials (also referred to as organoclays).

Especially preferred as inorganic thickener (a1) are phyllosilicate mixtures which have been surface-treated with quaternary alkylammonium salts and comprise 50 to 95 wt %, based on the phyllosilicate mixture, of a clay mineral selected from the group consisting of sepiolite and palykorskite or mixtures thereof, and less than 50 wt %, based on the phyllosilicate mixture, of at least one smectite. The 50 to 95 wt % of sepiolite and/or palykorskite together with the at least one smectite add up preferably to at least 95 wt %, more particularly to 100 wt %, based on the phyllosilicate mixture.

The smectite or the smectites may be selected in turn preferably from the group consisting of hectorite, montmorillonite, bentonite, beidelite, saponite, stevensite, and mixtures thereof.

The quaternary alkylammonium salts may be presented preferably in the general formula (C₁₋₁₀-alkyl)ₙ(C₁₂₋₂₂-alkyl)ₘ(benzyl)ₚN⁺X⁻, where n+m+p=4 and n=1 or 2, m=1 or 2, p=0 or 1, and X⁻=halide, preferably chloride, or sulfate. Particularly preferred quaternary alkylammonium salts are dimethyldi(C₁₄₋₁₈-alkyl)ammonium chloride, methylbenzyldi(C₁₄₋₁₈-alkyl)ammonium chloride, dimethylbenzyl(C₁₄₋₁₃-alkyl)ammonium chloride, and dimethyl(2-ethylhexyl) (C₁₄₋₁₃-alkyl) ammonium sulfate. The above C₁₄₋₁₈-alkyl radical is preferably a hydrogenated tallow-alkyl radical.

With particular preference the above-described phyllosilicate mixture is treated with 5 to 80 milliequivalents of the quaternary alkylammonium salt.

Thickeners of this kind are available from BYK Chemie GmbH, Wesel, Germany under the trade name Garamite®.

Further inorganic thickeners (a1) of the category of phyllosilicates are available for example under the trade names Laponite®, Claytone® or Cloisite®, likewise from BYK Chemie GmbH.

### Wetting and Dispersing Agents (a2)

The key requirement imposed on the wetting and dispersing agent (a2) is that it inhibits the thickening effect of the inorganic thickener (a1) (latent thickening).

The wetting and dispersing agents (a2) are agents which have one or more groups X with affinity to the thickener and therefore bind to the thickener surface covalently, ionically, and/or by physisorption. Moreover, they cause stabilization of the primary thickener particles and so prevent agglomeration, which leads otherwise to the sedimentation of the solids and hence separation of the millbase system. Responsible for this stabilization in general are one or more groups Y in the wetting and dispersing agent (a2) which ensure compatibility with the surrounding medium.

Wetting and dispersing agents (a2) used are preferably wetting and dispersing agents (a2) of relatively high molecular mass, more particularly polymeric wetting and dispersing agents (a2). Suitable functional polymers possess preferably a number-average molecular mass (Mₙ) of at least 400 g/mol, preferably at least 800 g/mol, more preferably at least 2000 g/mol. The maximum molecular weight Mₙ is usefully 100 000 g/mol, preferably 50 000 g/mol, and more preferably 25 000 g/mol. The number-average molecular weights can be determined by gel permeation chromatography against a polystyrene standard.

The wetting and dispersing agent (a2) used in accordance with the invention more particularly can be selected from the group of linear or branched polymers and copolymers having functional groups and/or groups with thickener affinity, alkylammonium salts of polymers and copolymers, polymers and copolymers having acidic groups, comb and block copolymers, such as block copolymers having, in particular, basic groups with thickener affinity, optionally modified acrylate block copolymers, optionally modified polyurethanes, optionally modified and/or optionally salified polyamines, epoxide-amine adducts, phosphoric esters, especially those of polyethers, polyesters, and polyether-esters, basic or acidic ethoxylates such as alkoxylated monoamines or polyamines or acidic 1,2-dicarboxylic anhydride monoesters of alkoxylated monoalcohols, reaction products of unsaturated fatty acids with mono-, di-, and polyamines, amino alcohols, and unsaturated 1,2-dicarboxylic acids and their anhydrides and their salts and reaction products with alcohols and/or amines; polymers and copolymers with fatty acid residues, optionally modified polyacrylates, such as transesterified polyacrylates, optionally modified polyesters, such as acid-functional and/or amino-functional polyesters, polyphosphates, and also mixtures thereof.

Especially preferred for selection as wetting and dispersing agents (a2) are those compounds as described in publications EP 0 154 678 B1, EP 0 270 126 B1, EP 0 318 999 B1, EP 0 417 490 B1, EP 0 879 860 B1, EP 0 893 155 B1, EP 1081 169 B1, EP 1416 019 A1, EP 1650 246 A1, EP 1742 90, EP 1803 753, EP 1837 355, EP 2668240, WO 2012175159, WO 2012175157, DE 102006048144, DE 102006062439, DE 102006062440, DE 102006062441, and DE 102007005720, more preferably the wetting and dispersing agents (a2) claimed in EP 0 893 155 B1 and EP 2 668 240.

Polymeric wetting and dispersing agents (a2) based on polyisocyanates are described for example in EP 0 154 678, EP 318 999, and EP 0 438 836. These products are prepared by addition reaction of monohydroxy compounds, diisocyanate-functional compounds, and compounds having a tertiary amino group onto the existing NCO groups of polyisocyanates containing isocyanurate, biuret, urethane and/or allophanate groups.

One preferred embodiment uses wetting and dispersing agents (a2) which are obtainable by salification of an amine-functional compound with an acid, the amine-functional compound used being a polyamine having at least three amino groups from the group of “unmodified, aliphatic linear or branched polyamines of the following group: “diethylenetriamine, triethylenetetramine, tetraethylenepentamine, pentaethylenehexamine, hexamethyleneheptamine, linear polymerizates of general formula NH₂—(C₂H₄NH)ₙ—C₂H₄—NH₂ with n>5, it being possible for protons on the nitrogen therein to have been replaced by alkyl, aryl and/or aralkyl groups and/or for the nitrogen to be in quaternized form, branched (C₂-C₄)-alkyleneamines and poly(C₂-C₄)alkyleneimines having tertiary amino groups and a number-average molecular weight of up to 1 000 000 g/mol or a mixture of such amines”; modified polyamines based on the aforesaid unmodified polyamines, these being polyamines reacted with mono- or polyisocyanates which possess v NCO groups of which (v-1) NCO groups have reacted beforehand with other reactants, polyamines reacted with epoxy-functional compounds, polyamines reacted with cyclic carbonates, polyamines reacted by a Michael reaction with α,β-unsaturated compounds, alkylated and/or quaternized polyamines and/or polyamines amidated with carboxylic acids, with the proviso that after the modification there are still three salifiable amino groups present per molecule, or a mixture of such polyamines and/or polyamines of the following group: “homo- or copolymerizates of amine-functional (meth)acrylates or vinyl compounds, and also amine-functional homo- or copolymers in which the amino group, by means of polymer-analogous reaction, was inserted into the pre-prepared polymer or generated on this polymer, or a mixture of such polyamines”, the homo- or copolymerizate having a number-average molecular weight of up to 1 000 000 g/mol”, and the acid used being a compound from the group of “phosphoric esters of the general formula: (OH)₃₋ₙPO(OR^{a})ₙ with n=1 or 2, sulfonic acids of the general formula HOSO₂R^{b}, acidic sulfuric esters of the general formula HOSO₃R^{b}” where R^{a} and R^{b} are an alkyl, aryl or aralkyl radical having at least 5 carbon atoms and/or a radical of an oxalkylated alcohol having a number-average molecular weight between 100 and 5000 g/mol and/or a radical having at least one carboxylic ester group and/or a urethane group with a number-average molecular weight between 100 and 5000 g/mol, or a mixture of such substances, where R^{a} and R^{b} are identical or different and, optionally, hydrogen atoms in the aliphatic groups of the radicals R^{a} and R^{b} have been replaced in part by halogen atoms, and the acid optionally carries further functional groups which behave inertly in the salification; and there being at least one amino group salified per molecule.

The following groups of wetting and dispersing agents (a2) display particularly good effect in the dispersions of the invention: (a) phosphoric ester salts of amino group-containing oligomers or polymers, such as, for example, phosphoric ester salts of optionally fatty acid-modified or alkoxylated (especially ethoxylated) polyamines, phosphoric ester salts of epoxide-polyamine adducts, phosphoric ester salts of amino group-containing acrylate or methacrylate copolymers, and phosphoric ester salts of acrylate-polyamine adducts, (b) monoesters or diesters of phosphoric acid, such as monoesters or diesters of phosphoric acid with alkyl, aryl, aralkyl or alkylaryl alkoxylates, for example (e.g., phosphoric monoesters or diesters of nonylphenol ethoxylates, isotridecyl alcohol ethoxylates, butanol-started alkylene oxide polyethers), mono- or diesters of phosphoric acid with polyesters (e.g. lactone polyesters, such as caprolactone polyesters or mixed caprolactone/valerolactone polyesters), (c) acidic dicarboxylic monoesters, examples being acidic dicarboxylic monoesters (especially of succinic acid, maleic acid or phthalic acid) with alkyl, aryl, aralkyl or alkylaryl alkoxylates (e.g., nonylphenol ethoxylates, isotridecyl alcohol ethoxylates or butanol-started alkylene oxide polyethers), (d) polyurethane-polyamine adducts, (e) polyalkoxylated monoamines or diamines (e.g., ethoxylated oleylamine or alkoxylated ethylenediamine), and (f) reaction products of unsaturated fatty acids with mono-, di-, and polyamines, amino alcohols, and unsaturated 1,2-dicarboxylic acids and their anhydrides and their salts and reaction products with alcohols and/or amines.

Wetting and dispersing agents (a2) of these kinds are available as commercial products from, for example, BYK-Chemie from Wesel, under the trade names BYK-220 S, BYK-P 9908, BYK-9076, BYK-9077, BYK-P 104, BYK-P 104 S, BYK-P 105, BYK-W 9010, BYK-W 920, BYK-W 935, BYK-W 940, BYK-W 960, BYK-W 965, BYK-W 966, BYK-W 975, BYK-W 980, BYK-W 990, BYK-W 995, BYK-W 996, BYKUMEN, BYKJET 9131, LACTIMON, ANTI-TERRA-202, ANTI-TERRA-203, ANTI-TERRA-204, ANTI-TERRA-205, ANTI-TERRA-206, ANTI-TERRA-207, ANTI-TERRA-U 100, ANTI-TERRA-U 80, ANTI-TERRA-U, LP-N-21201, LP-N-6918, DISPERBYK, DISPERBYK-101, DISPERBYK-102, DISPERBYK-103, DISPERBYK-106, DISPERBYK-107, DISPERBYK-108, DISPERBYK-109, DISPERBYK-110, DISPERBYK-111, DISPERBYK-112, DISPERBYK-115, DISPERBYK-116, DISPERBYK-118, DISPERBYK-130, DISPERBYK-140, DISPERBYK-142, DISPERBYK-145, DISPERBYK-160, DISPERBYK-161, DISPERBYK-162, DISPERBYK-163, DISPERBYK-164, DISPERBYK-165, DISPERBYK-166, DISPERBYK-167, DISPERBYK-168, DISPERBYK-169, DISPERBYK-170, DISPERBYK-171, DISPERBYK-174, DISPERBYK-176, DISPERBYK-180, DISPERBYK-181, DISPERBYK-182, DISPERBYK-183, DISPERBYK-184, DISPERBYK-185, DISPERBYK-187, DISPERBYK-190, DISPERBYK-191, DISPERBYK-192, DISPERBYK-193, DISPERBYK-194, DISPERBYK-2000, DISPERBYK-2001, DISPERBYK-2008, DISPERBYK-2009, DISPERBYK-2010, DISPERBYK-2020, DISPERBYK-2025, DISPERBYK-2050, DISPERBYK-2070, DISPERBYK-2090, DISPERBYK-2091, DISPERBYK-2095, DISPERBYK-2096, DISPERBYK-2150, DISPERBYK-2151, DISPERBYK-2152, DISPERBYK-2155, DISPERBYK-2163, DISPERBYK-2164, DISPERBLAST-1010, DISPERBLAST-1011, DISPERBLAST-1012, DISPERBLAST-1018, DISPERBLAST-I, DISPERBLAST-P. Where the desire is for a low content of volatile organic compounds, especially of organic solvents, the aforementioned commercial products ought as far as possible to be used as solvent-free active substances and ought where appropriate to be freed wholly or partly from volatile constituents by means of distillation, for example.

The inhibition of the thickening effect means that the inorganic thickener (a1) loses at least part of its otherwise present viscosity-increasing effect as a result of the presence of the wetting and dispersing agent (a2). These losses in viscosity increase are based on an interaction between the thickener and the wetting and dispersing agent. The inhibition of the thickening effect, in other words the thickening loss or lowering of the thickening effect of the inorganic thickener (a1) by the wetting and dispersing agent (a2), may also be reported on a percentage basis, as shown in the Examples section. In this case, the base value for the viscosity is the viscosity of a formulation measured, however, without addition of the wetting and dispersing agent (a2), and compared with an identical formulation which, however, contains the wetting and dispersing agent (a2). From this the percentage drop in viscosity arising from the presence of the wetting and dispersing agent (a2) is calculated. This percentage drop is preferably at least 10%, more preferably at least 20%, very preferably at least 40% or at least 80% or even at least 90% up to preferably 99.9%. The viscosity is determined as specified in the Examples section.

The inhibition of the thickening effect is produced preferably by a reversible binding of the wetting and dispersing agents (a2) to the surface of the inorganic thickener (a1).

Reversible binding of the wetting and dispersing agent (a2) is ought to be present at temperatures at which two- or multicomponent systems are customarily mixed. Reversibility is present preferably at temperatures below 80° C., more preferably at temperatures below 50° C., and very preferably at temperatures below 30° C., such as in particular at room temperature (23° C.)

In order to ensure reversibility of the binding, the wetting and dispersing agent (a2) is preferably selected such that weak intermolecular interactions—such as, for example, Van-der-Waals interactions, dipole-dipole interactions, or hydrogen bonds—are formed to the surface of the inorganic thickener and prevent partial or complete development of the rheological properties of the inorganic thickener.

In terms of their behavior, the wetting and dispersing agents (a2) are preferably substantially chemically inert to the other constituents of the polyester component 1.

The substantial chemical inertness relative to the constituents of the polyester component 1 may be achieved essentially in two ways. One option is to use a wetting and dispersing agent which contains no groups that are reactive toward the aforementioned constituents, or that triggers unwanted reactions through catalytic activity. A second option is to use wetting and dispersing agents in which, while there are potentially reactive groups present, these groups are nevertheless shielded—sterically, for example—in such a way that reaction with the constituents in the polyester component 1 under storage conditions takes place not at all or at a negligibly slow rate.

Wetting and dispersing agents (a2) with multi-capacity usefulness that are especially suitable for the purposes of the present invention prove to be wetting and dispersing agents which possess an amino group-containing polymeric backbone on which there are polyester and/or polyether and/or polyester and polyether side chains. Such wetting and dispersing agents are particularly suitable for those inorganic thickeners (a1) which are selected from the group of phyllosilicates, precipitated silicas, and fumed silicas, more particularly of phyllosilicates and fumed silicas, and very preferably of phyllosilicates and non-organically modified fumed silicas. The polyester and/or polyether and/or polyester and polyether side chains of such wetting and dispersing agents can be compressed when the inorganic thickeners are dispersed, with the adhesion forces of the aminic groups toward the thickener surface being strengthened. The aminic groups with thickener affinity are able then to adsorb to the thickener surface, while the side chains shield the aminic groups. Wetting and dispersing agents which comprise shielded aminic groups of this kind can therefore also be used in conjunction with those components of two- or multicomponent systems of the invention that are actually reactive toward aminic groups. At the same time, the wetting and dispersing agent shields the inorganic thickener (a1) and hinders it from full or partial development of its thickening effect.

Particularly suitable, for example, are reaction products of (a.) polyhydroxymonocarboxylic acids, which are preferably polyester-modified, with (b.) aziridine homopolymers, which are preferably polyester-modified, and (c.) monoisocyanates which carry polyester radicals, polyether radicals, polyester-polyether radicals or the radical of a hydroxycarboxylic acid, and last-mentioned compounds may be obtained for example, by reaction of an isocyanate group of a diisocyanate with the hydroxyl group of a hydroxycarboxylic acid. Products of this kind are disclosed in EP 2 668 240 A1, for example.

A wetting and dispersing agent (a2) which can be used and is particularly suitable in the context of this invention is, for example, the highly branched wetting and dispersing agent DISPERBYK-2151, from BYK Chemie GmbH, which has hitherto been recommended only for pigments and fillers. This wetting and dispersing agent allows outstanding dispersal of phyllosilicates, precipitated silicas, and fumed silicas, especially phyllosilicates and fumed silicas, in a multitude of chemically different components. There is compatibility, for example, with unsaturated polyesters as are used in two- or multicomponent systems of the invention.

The compatibility of the wetting and dispersing agent for the system in question is directly evident to a person of ordinary skill in the art when, for example, on account of the absence of complementary reactive groups, no reaction is expected, or the corresponding groups are sterically shielded. Accordingly in principle there is a multiplicity of suitable wetting and dispersing agents available. An ad hoc test as to whether steric shielding of potentially reactive groups in the wetting and dispersing agent is sufficient for it to be used in a particular two- or multicomponent system of the invention may be made by the person of ordinary skill in the art on the basis of simple rangefinding tests.

The combination of inorganic thickener (a1) and at least one wetting and dispersing agent (a2) may be solid at room temperature (23° C.). Hence this combination may preferably be an inorganic thickener (a1) coated with a wetting and dispersing agent (a2), preferably in powder form.

Since the wetting and dispersing agent (a2) are frequently used in the form in which they are obtained at synthesis the wetting and dispersing agents (a2) may also comprise, from the preparation process, auxiliaries used for the synthesis, such as catalysts, emulsifiers, and the like, for example. Such auxiliaries are considered as belonging to the solids content of the combination of inorganic thickener (a1) and at least one wetting and dispersing agent (a2).

### Accelerators

The accelerators, as they are called in the art, likewise dubbed to activators, possess the function of initiating the decomposition of peroxide, in the peroxides and hydroperoxides, which in general occurs only at elevated temperature, at just room temperature (23° C.)

Accelerators are therefore used when the initiators are peroxides and/or hydroperoxides. When photoinitiators are used in UV-curing unsaturated polyester resins, the use of an accelerator is unnecessary, since the UV radiation takes over its function in such a case. The use of accelerators is therefore optional and is only dependent on the particular initiator.

Preferred accelerators are selected from the group consisting of heavy metal salts and tertiary aromatic amines.

In the context of the present invention, however, the tertiary aromatic amines are used less preferably, since under certain circumstances they could intervene unfavorably in the interaction of the inorganic thickeners (a1) with the wetting and dispersing agents (a2) and could totally or partially prevent the lowering of the viscosity of the inorganic thickener (a1) with the wetting and dispersing agents.

Nevertheless, typical representatives from the group of tertiary aromatic accelerators are also given here, these accelerators, unlike the heavy metal salts identified later on below, not acting catalytically, but instead being consumed in the process of peroxide decomposition. Particularly noteworthy are the para- and meta-positionally substituted N,N-dialkylanilines, N,N-dialkyl-p-toluidine, and mercaptans.

Heavy metal salts deserving of mention are, in particular, the preferably organic salts of cobalt, of iron, of vanadium and of manganese. Especially preferred among these are the organic salts of cobalt, such as cobalt(II) octanoate, especially cobalt(II) -2-ethylhexanoate, or cobalt(II) naphthenate.

The heavy metal-based accelerators are especially suitable for hydroperoxides and peroxides. A typical ratio of cobalt to (hydro)peroxide is 0.001 to 0.01, more particularly about 0.005.

### Other Constituents of the Polyester Component 1

Besides the unsaturated polyester, the ethylenically unsaturated monomer, the inorganic thickener (a1), and the wetting and dispersing agent (a2), and also the accelerators possibly present, the polyester component 1 may also contain other constituents.

Other constituents include solvents, especially volatile organic solvents, and/or water. Customarily the two- or multicomponent systems of the invention are free or substantially free from volatile organic solvents and/or water, as already mentioned above.

Furthermore, the polyester component 1 may comprise further additives, of the kind customary in adhesives, sealants, coating materials, and molding compounds. Mention among these may be made in particular of defoamers, levelling agents or wetting and dispersing agents different from the wetting and dispersing agents (a2), catalysts, and, in particular, pigments and inorganic fillers different from the inorganic thickeners (a1), or else organic fillers.

### Initiator Component 2

### Initiator

Suitable initiators are, as already mentioned above, peroxides, hydroperoxides, and photoinitiators. The latter are activated with UV radiation, serving so to speak as an accelerator.

Peroxides can be accelerated particularly with the aforementioned tertiary aromatic amines, in some cases with heavy metal salts as well; for hydroperoxides, heavy metal salts are customarily used as accelerators, thus resulting in the following preferred initiator/accelerator combinations: hydroperoxides/heavy metal salts, peroxides/tertiary aromatic amines, and photoinitiators/“UV radiation”.

Preference is given to hydroperoxides of methyl ethyl ketone, of cyclohexanone and/or of acetylacetone, used in combination with organic cobalt(II) salts, or to dibenzoyl peroxide in combination with a tertiary aromatic amine. While combinations above operate even at room temperature (23° C.), preference in the case of curing temperatures of around 60 to 120° C. is given to using combinations of methyl isobutyl ketone peroxide with organic cobalt(II) salts.

Given that the peroxides and hydroperoxides are relatively unstable compounds, they are frequently admixed with what are called phlegmatizing agents, in order to lower the hazardousness, to render them less sensitive to impact. Phlegmatizing agents added may be small amounts of water, organic solvents and/or particular organic plasticizers such as, in particular, phthalic esters to the peroxide and/or hydroperoxide.

### Component (b1)

Component (b1) is characterized in that it at least partially eliminates the inhibition of the thickening effect of the inorganic thickener (a1) that is brought about by the wetting and dispersing agent (a2).

These can be monomeric compounds or oligomeric or polymeric species, there being no linguistic distinction here between oligomeric and polymeric species. Oligomeric species are therefore subsumed below within the polymeric species. In particular, certain of the species listed as curing agents above are suitable simultaneously as component (b1).

The binding of component (b1) preferably involves at least partially displacement of the wetting and dispersing agent (a2) from the thickener surface, meaning that the interaction of component (b1) with the surface of the inorganic thickener (a1) is generally stronger than the interaction of the wetting and dispersing agent (a2) with the surface of the inorganic thickener (a1).

As a consequence of this, the groups of component (b1) that have thickener affinity are customarily not shielded. Higher affinity, however, may also be obtained if the components (b1), for example, have a relatively large number of groups with thickener affinity, in comparison to the wetting and dispersing agent (a2), and/or if the nature of the groups with affinity permits stronger binding to the surface of the thickener.

It is essential that component (b1) again at least partially eliminates the inhibition, by the wetting and dispersing agent (a2), of the thickening effect of the inorganic thickener (a1). With particular preference the thickening effect of the thickener is not only entirely or at least partly restored, but in fact the sag resistance is stabilized, with—for example—the internal network of hydrogen bonds between the thickener particles being strengthened by component (b1).

A suitable component (b1), which has, for example, greater affinity for fumed silicas than does the wetting and dispersing agent DISPERBYK-2151, mentioned by way of example likewise above, is the high molecular mass polyethyleneimine having a weight-average molar mass of around 750 000 g/mol as is described in the above-cited EP 0 835 910 A1. It not only is capable of at least partially eliminating the inhibition by the wetting and dispersing agent of the thickening effect of the thickener, but additionally stabilizes the network between the thickener particles that is responsible for the sag resistance. Other polymeric amines and fatty acid-salified polyethyleneimines as well, however, preferably tall oil fatty acid-salified polyethyleneamines, are suitable as component (b1).

Further suitable components (b1) are, for example, condensation products of dimer and/or trimer fatty acids, which may also be used in a mixture with monomeric fatty acids, with amines. Amines suitable for this purpose are, in particular, aliphatic and cycloaliphatic or else aromatic amines or mixtures of the aforesaid amines. Examples of such amines are m-xylylenediamine, 1,6-diaminohexane, isophoronediamine (isomer mixture; IPDA), triethylenetetramine (TETA); diethylenetriamine, tetraethylenepentamine, pentaethylenehexamine (isomer mixture), 1,3-diaminopropane, dipropylenetriamine or 2-(2-(2-aminoethylamino)ethylamino)ethanol or diethanolamine.

Also suitable as component (b1) are nonpolymeric monoamines and preferably polyamines, more particularly those which possess molecular uniformity and/or possess comparatively low number-average molecular weights Mₙ, such as, for example, polyalkylenepolyamines such as, for example, triethylenetetramine, but also cycloaliphatic diamines such as, for example, isophoronediamine.

Likewise suitable are monoetheramines such as diglycolamine (DGA), but also, in particular, polyetheramines of the kind, for example, available commercially from Huntsman under the trade name Jeffamine®, such as Jeffamine® T-403.

Likewise suitable are polyethylene oxide polyols such as polyoxyethylene sorbitan monolaurate (TWEEN 20), for example.

Component (b1) may be liquid or solid. Preferably component (b1) is liquid.

Since component (b1) is frequently used in the form in which it is obtained at synthesis, component (b1) may as a result of production also include auxiliaries used for the synthesis, such as catalysts and stabilizers, and the like, for example.

The selection of a suitable component (b1) is preferably made in a targeted way, taking account of the choice of the wetting and dispersing agent (a2).

Thus the component (b1) customarily possesses more polar and/or more basic groups with surface affinity than does the wetting and dispersing agent (a2), with the surface affinity relating to the surface of the inorganic thickener (a1). Where groups with surface affinity that are of similar polarity and/or basicity to those in component (b1) are present in the wetting and dispersing agent (a2), component (b1) preferably contains a greater weight-percentage fraction of groups with surface affinity in component (b1), compared with the weight percentage fraction of groups with surface affinity that are present in the wetting and dispersing agent (a2). With particular preference, in comparison to the wetting and dispersing agent (a2), component (b1) comprises not only a greater weight percentage fraction of groups with affinity for the surface of the inorganic thickener (a1) but also groups with surface affinity which are more polar and/or more basic in comparison to the groups with surface affinity in the wetting and dispersing agent (a2), very preferably groups with surface affinity which are more polar and more basic in comparison to the groups with surface affinity of the wetting and dispersing agent (a2).

On the other hand this means that when selecting the wetting and dispersing agent (a2), the wetting and dispersing agent that must be or ought to be selected is not the one that is “best” for dispersing of the inorganic thickener (a1), affording the maximum reduction in viscosity in relation to the inhibition of the thickening effect. Excessively strong binding of the wetting and dispersing agent (a2) to the thickener surface is specifically not desired, in order not to make it unnecessarily difficult for component (b1) to displace the wetting and dispersing agent (a2) from the surface of the inorganic thickener (a1).

The aim, therefore, is to achieve adequate to very good reduction in viscosity by the wetting and dispersing agent (a2), but not a perfect dispersal of the inorganic thickener (a1), allowing the component (b1), in a second step, to enter into very good to perfect interaction with the surface of the inorganic thickener (a1), so that an increase in viscosity occurs.

The wetting and dispersing agent (a2) is preferably selected such that it has only a few groups with thickener affinity. In respect of the groups with thickener affinity, therefore, monofunctional wetting and dispersing agents (a2) can also be used advantageously. If they do not contain only one group with thickener affinity, it is advantageous for the groups with thickener affinity to be located spatially close to one another. The effect of this is that they are not capable of building up a pronounced stabilizing network.

For component (b1), in contrast, it counteracts the steric stabilization of the inorganic thickener (a1) by the wetting and dispersing agent, and enters into very good to perfect interaction with the thickener surface.

Structural units entering into the calculation of the adhesion group fraction in the wetting and dispersing agent (a2) and/or in component (b1) are considered to be only the structural units reported in the “Adhesion groups” table below, which occur in different moieties in (a2) and (b1).

“Adhesion groups” table

| Structural | | |
|---|---|---|
| element | Moiety in (a2) or (b1) | |
| C(O)N | Amide of secondary amines | |
| C(O)NH | Amide of primary amines | |
| C(O)NH₂ | Amide of ammonia | |
| OH | Alcohol | |
| N—C═N | Imidazoline | |
| NC(O)N | Urea of secondary amines | |
| HNC(O)NH | Urea of primary amines | |
| NH₂ | Primary amine | |
| NH | Secondary amine | |
| N | Tertiary amine | |
| XNH₃ | Ammonium salt of primary amines | where X is |
| XNH₂ | Ammonium salt of secondary amines* | the anion of |
| XNH | Ammonium salt of tertiary amines** | an acid group |

| | |
|---|---|
| OP(O)(OH)2 | Organic phosphoric ester |
| C(O)OH | Carboxylic acid |

*Example: ammonium carboxylate of secondary amine = COONH₂
**Example: ammonium chloride of tertiary amine = ClNH

The calculation takes place typically starting from the starting compounds to be used for the synthesis of (a2) and (b1) and from the structural elements to be expected therefrom, in which case a 100% conversion may be assumed, or, in knowledge of the structure, the structural elements are derived from the compounds.

A general criterion for selection is that wetting and dispersing agents (a2) in comparison to the components (b1) possess a much smaller weight percentage fraction of adhesion groups, based on the total weight of the wetting and dispersing agent (a2), than is the case for the species of component (b1). Generally it has emerged that wetting and dispersing agents (a2) which can be used with preference in this invention possess a weight percentage fraction of structural elements of adhesion groups of preferably <11 wt % based on the total wetting and dispersing agent (a2), while in component (b1) the weight percentage fraction of structural elements of the adhesion groups is preferably 11 wt %.

These limits are not hard and fast, instead serving for a targeted selection of the appropriate components. For particularly preferred wetting and dispersing agents (a2) it is the case that the above structural element fraction is <9 wt %, more preferably <6 wt %, and very preferably <4 wt %, or even <3 wt %, while for preferred components (b1) the above structural element fraction is preferably >13 wt %, more preferably >20 wt %, very preferably indeed >30 wt % or even >40 wt %.

The structural element fraction in the wetting and dispersing agent (a2) ought, however, preferably to be not below 0.5 wt %, more preferably not below 0.8 wt %, since otherwise the thickening-inhibiting effect is inadequate owing to lack of affinity for the thickener surface.

The difference in the weight percentage fractions of structural elements in the wetting and dispersing agent (a2) relative to the weight percentage fraction of structural elements in components (b1) is preferably at least 2 wt %, more preferably at least 5 wt %, and very preferably at least 10 wt %.

In the above calculations, of course, only the wetting and dispersing agent (a2) and the component (b1) are included, respectively, in each case without any solvents present or other auxiliaries that may be present as a result of synthesis.

The gradation below may be taken as a general affinity series of different groups with surface affinity for typical thickener surfaces:

[Group 1]: imidazolines ≧(amines, ammonium compounds)

[Group 2]: alcohols ≧(ureas, amides, carboxylic acids, phosphoric esters),

where the groups of group 1 generally have greater affinity for the thickener surface of the inorganic thickener (a1) than to those of group 2; in other words [group 1]>[group 2].

It is generally the case that groups with greater affinity are present preferably in component (b1), while the wetting and dispersing agents (a2) ought preferably to contain groups with less affinity.

It is the case, generally, that the wetting and dispersing agent (a2) and the component (b1) are selected such that they comprise one or more of the following functional groups selected from group 1: consisting of
imidazolyl groups, with the structural element N—C═N,
amino groups with the structural elements N for tertiary amines, NH for secondary amines, and NH₂ for primary amines, and
ammonium groups with the structural element NH⁺X⁻ for ammonium salts of tertiary amines, with the structural element NH₂⁺X⁻ for ammonium salts of secondary amines, and NH₃⁺X⁻ for ammonium salts of primary amines, X⁻ in each case being the anion of an acid;

and/or

group 2: consisting of
hydroxyl groups with the structural element OH,
urea groups with the structural element HNC(O)CNH for ureas of primary amines and NC(O)CN for ureas of secondary amines,
amide groups, with the structural element C(O)N for amides of secondary amines, C(O)NH for amides of primary amines, and C(O)NH₂ for amides of ammonia,
carboxylic acid groups with the structural element COOH, and
organic phosphoric ester groups with the structural element OP(O)(OH)₂,
and
(A) the weight percentage fraction of structural elements in the wetting and dispersing agent (a2), selected from the functional groups of groups 1 and 2, based on the weight of the wetting and dispersing agent (a2), being lower than the weight percentage fraction of structural elements in component (b1), selected from the functional groups of groups 1 and 2, based on the weight of the component (b1);
and/or
(B) component (b1) comprising a higher weight percentage fraction of structural elements from the functional groups selected from group 1, based on the weight of component (b1), than that of the structural elements from the functional groups selected from group 1 in the wetting and dispersing agent (a2), based on the weight of the wetting and dispersing agent (a2).

The selection rules make it possible on the one hand to select, reliably, suitable pairings of wetting and dispersing agents (a2), and components (b1) on the other hand. The extent of the increase in viscosity with component (b1) is dependent, however, on other factors, such as the structures of the wetting and dispersing agents (a2) and of the component (b1), for example, something which, however, is merely a matter of the extent of the effect, but does not jeopardize the performability of the invention.

Frequently and in general, the extent of the increase in viscosity can be raised by increasing the amount of component (b1) in relation to the wetting and dispersing agent (a2).

The weight ratio of the wetting and dispersing agent (a2) to the component (b1) is preferably about 25:1 to 1:10, more preferably 20:1 to 1:8, very preferably 15:1 to 1:6.

It is customarily the case, for the ratio of (a2) to (b1), that (a2) is used in excess, relative to the weight of the two components, in other words (a2):(b1)=>1:1, more preferably up to 15:1. If the increase of the thickening effect is not sufficient in such a case, it is advisable to increase the amount of (b1) up to a ratio of typically (a2):(b1)=1:5. It is of course also possible to raise the amount of (b1) beyond this ratio. In the latter case, however, it is advisable instead, optionally, to use a more potent component (b1), which has more functional groups and/or functional groups with greater thickener affinity.

### Other Constituents of the Initiator Component 2

The initiator component 2 as well may comprise other organic solvents and/or water, and also other additives of the kind customary in adhesives, sealants, coating materials, and molding compounds. In this regard, reference is made to the other constituents of the polyester component 1.

The two- or multicomponent systems of the invention are preferably adhesives, sealants, coating materials or molding compounds.

Typical fields of application for the unsaturated polyester two- or multicomponent systems of the invention are furniture coating, marine finishing, the production of paints and filling compounds, especially for metals and mineral substrates, such as natural stone, the impregnation of fibers, woven fabrics, and nonwovens, where the material of the fibers, woven fabrics or nonwovens belongs preferably to the group consisting of carbon or glass, mineral substances, and organic polymers. The two- or multicomponent systems of the invention therefore serve preferably for producing composite materials, especially filler-reinforced and/or fiber-reinforced plastics.

A further subject of the present invention is the use of the latent thickener in a formulation which is inert toward the latent thickener, in order to provide the formulation with a latent thickening effect. The formulation in question is preferably a formulation comprising an unsaturated polyester as described in the present invention.

The two- or multicomponent systems of the present invention are suitable generally for all substrates to be adhesively bonded, to be coated or to be sealed. As suitable substrate materials, mention may be made, by way of example, of glass, metals and their alloys, plastics such as, for example, also composite materials, painted surfaces, films and foils, paper and cardboard packaging, wood, Eternit, concrete, wovens such as, for example, fabrics or carpet materials, tiles and many other different materials.

The invention is described in more detail below, using examples.

### EXAMPLES

### Preparation Examples

In the case of molecularly nonuniform substances, the stated molecular weights—below and in the foregoing description—represent average values of the numerical average. The molecular weights, or number-average molecular weights Mₙ, are determined—where there are determinable functional end groups present such as hydroxyl, NCO, amino or acid groups—by end group determination via ascertainment of OH number, NCO number, amine number or acid number by titration, respectively. In the case of compounds for which end group determination is not applicable, the number-average molecular weight is determined by gel permeation chromography against a polystyrene standard. Molecular weights reported for the polyamines are number averages Mₙ determined by ebullioscopy.

Unless otherwise stated, amounts in parts are parts by weight and amounts in percent are percentages by weight.

### Viscosity Measurements

The viscosities of the base components and of the mixtures of the base components were determined—unless otherwise specified—on a Stresstech instrument from Rheologica via a plate-cone method (cone diameter 25 mm; cone angle: 1°; cone-plate gap: 35 μm; temperature: 23° C.; shear rate 1 s⁻¹; number of data points: 21; compensation time 10 s; measuring time per data point: delay time+integration time; delay time: 5-8 s; integration time: 3 s; control strength (sensitivity): 60%).

The measurements on two-, three- and multicomponent systems were carried out 2 minutes after their preparation.

The viscosities of the base components and of the mixtures of the base components were determined—where the Brookfield method is reported—on a Brookfield DV-II+viscometer from Brookfield via spindle method (spindle 3; 5 rpm, temperature: 23° C.; measuring time per data point: 1 min). The measurements on two-, three- and multicomponent systems were carried out 2 minutes after their preparation.

### Determination of Tertiary Nitrogen Content

The tertiary nitrogen content indicates the percentage content of bound tertiary basic nitrogen in a sample under analysis. The method of determination uses the fact that tertiary amino groups—in contrast to primary and secondary amino groups—do not react with anhydrides to form amides. When primary and secondary amino groups are acetylated with acetic anhydride, the tertiary amino groups can be subsequently titrated quantitatively with perchloric acid. For determining the tertiary nitrogen content of a sample, a quantity of a sample under analysis is weighed to a precision of 0.1 mg on an analytical balance into an 80 ml glass beaker. The quantity to be weighed out of the amount to be analyzed is guided by the anticipated tertiary nitrogen content and is taken from the table below:

| Anticipated tertiary | Sample quantity to be |
|---|---|
| nitrogen content [%] | weighed out [g] |
| 0-0.3 | 3-5 |
| 0.3-0.6 | 1.5-3 |
| 0.6-0.9 | 1.0-1.5 |
| 0.9-1.5 | 0.6-1.0 |
| 1.5-2.0 | 0.45-0.6 |
| 2.0-3.0 | 0.30-0.45 |
| 3-5 | 0.15-0.30 |
| 5-10 | 0.08-0.15 |
| 10-20 | 0.06-0.08 |

The sample is dissolved in 20 ml of acetic acid (99.8% strength) and 30 ml of acetic anhydride (98.5% strength). The resulting sample solution is then fitted with a ground glass lid and heated in a thermoblock or waterbath at 70° C. for a time of 30 minutes. When the sample solution has cooled, it is placed on a magnetic stirrer and an Ag/AgCl combination electrode is immersed into the sample solution. The combination electrode is part of a microprocessor-controlled analytical apparatus (Titrator DL77, DL70 ES or DL67) from Mettler. The sample solution is titrated with perchloric acid (0.1 N in acetic acid, anhydride-free). The tertiary nitrogen content is determined by the analytical apparatus used. The tertiary nitrogen content is calculated as follows:

$$Tertiary N content ( wt \% ) = \frac{consumption ml \times N \times f \times 1.4008}{initial mass in g}$$

$$N = normality of the titrant$$

$$f = factor of the titrant$$

The factor f here takes account where appropriate of any deviation in the titrant used from a normality of 0.1 N.

### Inorganic Thickeners (a1)

Inorganic thickeners used were two different kinds of commercially available fumed silica (available from Evonik Industries) which differ in their BET surface area, namely:

### (a1.1)=Aerosil® 200 (BET 200) and

### (a1.2)=Aerosil® 380 (BET 380).

Also used were three different modified phyllosilicate mixtures, available commercially from Byk Chemie GmbH under the brand name Garamite®, namely:

(a1.3)=Garamite® 7305 (mixture of different bentonites, modified with quaternary ammonium compounds)
(a1.4)=Garamite® 1210 (mixture of different bentonite, modified with quaternary ammonium compounds)
(a1.5)=Garamite® 1958 (mixture of different bentonite, modified with quaternary ammonium compounds)

### Wetting and Dispersing Agents (a2)

### Preparation of (a2.1)

### Precursor A

30 g of Epomin SP-018 (from Nippon Shokubai) are heated to 80° C. Over a period of two hours, 70 g of 2-ethylhexyl acrylate are added dropwise, after which reaction is allowed to continue for six hours.

### Precursor B

92% of polyether (butanol-started EO/PO polyether (about 1:1), Mw about 1100 Da) is heated to 60° C. 7.6 g of polyphosphoric acid are slowly added dropwise. The reaction mixture is stirred for six hours until there is no further rise in the acid number (acid number as per DIN EN ISO 2114) in the flask.

Synthesis of the Compound from Precursors A and B

20 g of precursor A are introduced at 60° C. and 80 g of precursor B are metered in slowly over a period of two hours. The reaction mixture is stirred at 60° C. for five hours.

The product obtained has an active substance content of 100%.

### Preparation of (a2.2)

A reaction vessel was charged with 205 g of tetrahydrofuran, and 0.11 ml of 1M tetrabutylammonium 3-chlorobenzoate in acetonitrile and 1.94 g of 1-methoxy-1-trimethylsiloxy-2-methylpropane are added. The reaction vessel was cooled to −10° C. In parallel to an addition over 40 minutes of a mixture consisting of 39.6 g of 2-ethylhexyl methacrylate, 20 g of methyl methacrylate and 2.84 g of butyl methacrylate, a dilution of 0.22 ml of 1M tetrabutylammonium 3-chlorobenzoate in acetonitrile in 5 ml of tetrahydrofuran was added over a period of one hour. At no point did the reaction temperature exceed the temperature of 25° C.

Then 20.9 g of N,N-dimethylaminoethyl methacrylate were added dropwise over a period of 10 minutes, and in parallel a further 0.11 ml of 1M tetrabutylammonium 3-chlorobenzoate in acetonitrile was metered in over a period of 10 minutes. After a further three hours of stirring at a temperature (23° C.), 5 ml of methanol were added. Following addition of 6.7 g of benzyl chloride, stirring is carried out at 60° C. for a further six hours.

Methoxypropyl acetate is then added to the product, and the tetrahydrofuran present is removed by distillation, and the fraction of nonvolatiles (2.0±0.1 g test substance, duplicate determination, 10 minutes, 150° C.; EN ISO 3251) is adjusted to 40%.

### Preparation of (a2.3)

### Precursor A

100 g of dimethylolpropionic acid (from Perstorp), 255.26 g of ε-caprolactone and 74.64 g of δ-valerolactone were admixed with dibutyltin dilaurate (200 ppm) and stirred under inert gas at 170° C. until the fraction of nonvolatiles (2.0±0.1 g test substance, duplicate determination, 10 minutes, 150° C.; EN ISO 3251) exceeded a figure of 98%.

### Precursor B

435 g of Desmodur T100 (from Bayer) are introduced under nitrogen and 1100 g of the dry (Karl Fischer water content <0.1%) polyether (butanol-started PO polyether, Mw about 1100 Da) are added slowly dropwise such that the reaction temperature does not exceed 60° C. After the end of the addition, stirring is continued at 60° C. until the NCO number of the product shows no significant change over a period of 30 minutes.

Then the remaining excess of Desmodur T100 is removed by distillation using a thin-film or short-path evaporator.

Synthesis of the compound from precursors A and B 1.2 g of Epomin SP200 (from Nippon Shokubai) are heated together with 59.0 g of precursor A to 180° C. under nitrogen. The batch was stirred at this temperature until the acid number (AN as per DIN 53402) reached a figure of 8.4 mg KOH/g substance. During the reaction, the water of reaction formed was distilled off at the reaction temperature selected and was collected in a water separator. Then the hydroxyl number (as per DIN/ISO 4629) of the resulting product was determined, and 50% of the hydroxyl groups were reacted at a temperature at 60° C. by addition of precursor B and four-hour stirring under nitrogen.

The product is obtained as a brown oil of high viscosity, the active substance concentration being 100%.

### Preparation of (a2.4)

### Precursor A

100 g of dimethylolpropionic acid (from Perstorp), 255.26 g of ε-caprolactone and 74.64 g of δ-valerolactone were admixed with dibutyltin dilaurate (200 ppm) and stirred under inert gas at 170° C. until the fraction of nonvolatiles (2.0±0.1 g test substance, duplicate determination, 10 minutes, 150° C.; EN ISO 3251) exceeded a figure of 98%.

Precursor B

435 g of Desmodur T100 (from Bayer) are introduced under nitrogen and 1100 g of the dry (Karl Fischer water content <0.1%) polyether (butanol-started PO polyether, Mw about 1100 Da) are added slowly dropwise such that the reaction temperature does not exceed 60° C. After the end of the addition, stirring is continued at 60° C. until the NCO number of the product shows no significant change over a period of 30 minutes.

Then the remaining excess of Desmodur T100 is removed by distillation using a thin-film or short-path evaporator.

Synthesis of the Compound from Precursors A and B

1.2 g of Epomin SP200 (from Nippon Shokubai) are heated together with 59.0 g of precursor A to 180° C. under nitrogen. The batch was stirred at this temperature until the acid number (AN as per DIN 53402) reached a figure of 7.8 mg KOH/g substance. During the reaction, the water of reaction formed was distilled off at the reaction temperature selected and was collected in a water separator. Then the hydroxyl number (as per DIN/ISO 4629) of the resulting product was determined, and 50% of the hydroxyl groups were reacted at a temperature at 60° C. by addition of precursor B and four-hour stirring under nitrogen.

The resulting product is subsequently diluted for further use to 80% in methoxypropyl acetate.

### Preparation of (a2.5)

### Precursor A

134 g of dimethylolpropionic acid (from Perstorp), 342 g of ε-caprolactone and 100 g of δ-valerolactone were admixed with dibutyltin dilaurate (200 ppm) and stirred under inert gas at 170° C. until the fraction of nonvolatiles (2.0±0.1 g test substance, duplicate determination, 10 minutes, 150° C.; EN ISO 3251) exceeded a figure of 98%.

Precursor B 435 g of Desmodur T100 (from Bayer) are introduced under nitrogen and 1100 g of the dry (Karl Fischer water content <0.1%) polyether (butanol-started PO polyether, Mw about 1100 Da) are added slowly dropwise such that the reaction temperature does not exceed 60° C. After the end of the addition, stirring is continued at 60° C. until the NCO number of the product shows no significant change over a period of 30 minutes.

Then the remaining excess of Desmodur T100 is removed by distillation using a thin-film or short-path evaporator.

Synthesis of the Compound from Precursors A and B

10 g of Epomin SP006 (from Nippon Shokubai) are heated together with 550 g of precursor A to 180° C. under nitrogen. The batch was stirred at this temperature until the acid number (AN as per DIN 53402) reached a figure of 10.3 mg KOH/g substance. During the reaction, the water of reaction formed was distilled off at the reaction temperature selected and was collected in a water separator. Then the hydroxyl number (as per DIN/ISO 4629) of the resulting product was determined, and 50% of the hydroxyl groups were reacted at a temperature at 60° C. by addition of precursor B and four-hour stirring under nitrogen.

The resulting product is subsequently diluted for further use to 80% in benzyl alcohol.

Preparation of (a2.6) 250 g of polyether (methanol-started EO polyether, Mw about 500 Da) are admixed with 181 g of ε-caprolactone and heated to 80° C. Then 1000 ppm of toluenesulfonic acid are added. The reaction mixture is stirred until the fraction of nonvolatiles (2.0±0.1 g test substance, duplicate determination, 10 minutes, 150° C.; EN ISO 3251) exceeds a figure of 98%. then 650 ppm of dibutylethanolamine are added and the reaction mixture is stirred for 10 minutes more.

51 g of polyphosphoric acid are metered in. The reaction mixture is stirred for three hours until the acid number (acid number as per DIN EN ISO 2114) in the flask shows no further increase. Then 5 g of water, 900 g of methoxypropyl acetate and 19 g of magnesium oxide are added and the reaction mixture is homogenized at 100° C. for an hour. Excess water is removed under reduced pressure until the Karl-Fischer water content (as per DIN 51777) reaches a figure <0.2%.

The active substance content is subsequently adjusted to a level of 40%, by determination of the fraction of nonvolatiles (2.0±0.1 g test substance, duplicate determination, 10 minutes, 150° C.; EN ISO 3251).

### Preparation of (a2.7)

30 g of Epomin SP-018 (from Nippon Shokubai) are heated to 80° C. Over a period of two hours, 70 g of 2-ethylhexyl acrylate are added dropwise, after which reaction is allowed to continue for six hours.

The resulting product has an active substance concentration of 100%.

### Preparation of (a2.8)

65 g of synthetic resin SMA 2000 (styrene-maleic anhydride copolymer, 187 mmol of anhydride groups, from Cray Valley) are diluted in 100 g of methoxypropyl acetate and admixed slowly with a mixture of 105 g of Jeffamin M2070 (amine-terminated EO/PO polyether, from Huntsman) and 10.2 g of N,N-dimethylaminopropylamine and heated at 170° C. for four hours. During this time the methoxypropyl acetate present is removed by distillation. Then 8.9 g of benzyl chloride are added at 70° C. and the batch is reacted for eight hours.

The product obtained is admixed with a mixture of methoxypropyl acetate and butyl glycol (ratio 1:1, by weight) until the active substance content is 40%.

Preparation of (a2.9) 65 g of synthetic resin SMA 2000 (styrene-maleic anhydride copolymer, 187 mmol of anhydride groups, from Cray Valley) are diluted in 100 g of methoxypropyl acetate and admixed slowly with a mixture of 105 g of Jeffamin M2070 (amine-terminated EO/PO polyether, from Huntsman) and 10.2 g of N,N-dimethylaminopropylamine and heated at 170° C. for four hours. During this time the methoxypropyl acetate present is removed by distillation.

The product obtained is admixed with a mixture of methoxypropyl acetate and butyl glycol (ratio 1:1, by weight) until the active substance content is 40%.

### Preparation of (a2.10)

### Precursor A

A reaction vessel was charged with 205 g of tetrahydrofuran, and 0.11 ml of 1M tetrabutylammonium 3-chlorobenzoate in acetonitrile and 1.94 g of 1-methoxy-1-trimethylsiloxy-2-methylpropane were added. The reaction mixture was cooled to −10° C. In parallel to an addition over 40 minutes of a mixture consisting of 39.6 g of 2-ethylhexyl methacrylate, 20 g of methyl methacrylate and 2.84 g of butyl methacrylate, a dilution of 0.22 ml of 1M tetrabutylammonium 3-chlorobenzoate in acetonitrile in 5 ml of tetrahydrofuran was added over a period of one hour. At no point did the reaction temperature exceed the temperature of 25° C.

Then 20.9 g of N,N-dimethylaminoethyl methacrylate were added dropwise over a period of 10 minutes, and in parallel a further 0.11 ml of 1M tetrabutylammonium 3-chlorobenzoate in acetonitrile was metered in over a period of 10 minutes.

After a further three hours of stirring at room temperature (23° C.), 5 ml of methanol were added.

### Precursor B

87 g of polyether (butanol-started PO polyether, Mw about 700 Da) is heated to 60° C. 13 g of polyphosphoric acid are slowly added dropwise. The reaction mixture is stirred for six hours until there is no further rise in the acid number (acid number as per DIN EN ISO 2114) in the flask.

Synthesis of the compound from precursors A and B 120 g of precursor A are admixed with 50 g of polyether (methanol-started EO polyether, Mw about 350) and the solvent present is distilled off under reduced pressure. The remaining batch is then heated to 60° C., 14 g of precursor B are added, and the mixture is stirred at this temperature for eight hours.

The product obtained has an active substance concentration of 50%.

### Preparation of (a2.11)

15.2 g of alpha-methylstyrene dimer are introduced in 120 g of methoxypropyl acetate and heated to 120° C. 100 g of dimethylaminoethyl methacrylate and 1.5 g of AlBN in solution in 10 g of methoxypropyl acetate are metered in parallel over a period of 60 minutes, after which reaction is allowed to continue for 30 minutes. Then a mixture of 60 g of methyl methacrylate, 20 g of 2-ethylhexyl methacrylate, 50 g of 2-ethylhexyl acrylate and 230 g of butyl acrylate is metered in parallel to a solution of 37.2 g of AlBN in 240 g of methoxypropyl acetate over a period of 150 minutes, after which reaction is allowed to continue for 30 minutes.

Then 100 g of dimethylaminoethyl methacrylate and, in parallel, 1.2 g of AlBN in solution in 10 g of methoxypropyl acetate are metered in over a period of 60 minutes, after which reaction is allowed to continue for 30 minutes.

After a further addition of 0.4 g of AlBN in solution in 5 g of methoxypropyl acetate, over a period of 15 minutes, reaction is allowed to continue for 60 minutes.

The product obtained has an active substance content of 60%.

### Preparation of (a2.12)

### Precursor A

15 g of tall oil fatty acid (acid number: 186 mg KOH/g substance) and 10 g of polyethylene glycol 200 are heated together slowly at 200° C. until water which forms can no longer be collected. Reduced pressure (beginning at atmospheric pressure, slow reduction to 60 mbar) is applied for 2 hours. Then 4 g of maleic anhydride are added. Reaction is allowed to take place for an hour at 200° C.

Precursor B

17 g of tall oil fatty acid (acid number: 186 mg KOH/g substance) and 3.0 g of diethylenetriamine are combined and heated at 170° C. for four hours. Water of reaction produced is removed by distillation, followed by stirring under reduced pressure (60 mbar) for a further two hours.

Then 2 g of water are added and the mixture is stirred at 95° C. for 30 minutes until the tertiary nitrogen content (see description of method) is no longer detectable. Then again reduced pressure (60 mbar) is applied and excess water is removed by distillation until the Karl-Fischer water content (as per DIN 51777) reaches a figure <0.4%.

Synthesis of the Compound from Precursors A and B

25 g of precursor A and 20 g of precursor B are stirred homogeneously together with 45 g of Isopar G (hydrogenated C10-C12 isoalkanes, <2% aromatic content) at 80° C. for an hour.

The product obtained has an active substance content of 50%.

### Preparation of (a2.13)

### Precursor A

88 g of Lutensol A011 (fatty alcohol-started EO polyether from BASF SE) are admixed with 0.05 g of potassium carbonate and heated to 100° C. Subsequently, 12 g of maleic anhydride are added and the mixture is stirred at this temperature for three hours.

Precursor B 270 g of methoxypropyl acetate and 18 g of alpha-methylstyrene are heated to 120° C. In parallel, 300 g of butyl methacrylate and a solution of 7.2 g of AlBN in 40.8 g of methoxypropyl acetate are metered in over a period of two hours. After further reaction for a period of 30 minutes, in parallel, 163 g of N,N-dimethylaminoethyl methacrylate and a solution of 1.43 g of AlBN in 8.2 g of methoxypropyl acetate are metered in over a period of one hour. After further reaction for a period of 30 minutes, a solution of 1.4 g of AlBN in 8 g of methoxypropyl acetate is metered in over a period of 15 minutes and the mixture is stirred for a further hour.

Synthesis of the compound from precursors A and B 40 g of precursor B, 20 g of precursor A and 13.3 g of methoxypropyl acetate are stirred together at 120° C. for five hours.

The product obtained has an active substance content of 60%.

### Preparation of (a2.14)

### Precursor A

100 g of dimethylolpropionic acid (from Perstorp), 255.26 g of ε-caprolactone and 74.64 g of ε-valerolactone were admixed with dibutyltin dilaurate (200 ppm) and stirred under inert gas at 170° C. until the fraction of nonvolatiles (2.0±0.1 g test substance, duplicate determination, 10 minutes, 150° C.; EN ISO 3251) exceeded a figure of 98%.

### Precursor B

435 g of Desmodur T100 (from Bayer) are introduced under nitrogen and 1100 g of the dry (Karl Fischer water content <0.1%) polyether (butanol-started PO polyether, Mw about 1100 Da) are added slowly dropwise such that the reaction temperature does not exceed 60° C. After the end of the addition, stirring is continued at 60° C. until the NCO number of the product shows no significant change over a period of 30 minutes.

Then the remaining excess of Desmodur T100 is removed by distillation using a thin-film or short-path evaporator.

Synthesis of the Compound from Precursors A and B

1.2 g of Epomin SP200 (from Nippon Shokubai) are heated together with 59.0 g of precursor A to 180° C. under nitrogen. The batch was stirred at this temperature until the acid number (AN as per DIN 53402) reached a figure of 9.6 mg KOH/g substance. During the reaction, the water of reaction formed was distilled off at the reaction temperature selected and was collected in a water separator. Then the hydroxyl number (as per DIN/ISO 4629) of the resulting product was determined, and 50% of the hydroxyl groups were reacted at a temperature at 60° C. by addition of precursor B and four-hour stirring under nitrogen. The resulting product is subsequently diluted for further use to 80% in benzyl alcohol.

### Component (b1)

### Preparation of (b1.1)

881 g of a mixture of polymerized fatty acids having a trimerized fatty acid fraction of >75 wt %, based in each case on the total weight of the mixture, with an acid number of 191 mg KOH/g substance (Pripol 1040, from Croda) are admixed with 438 g of triethylenetetramine (CAS No.: 112-24-3) and 400 ml of solvent naphtha (aromatic hydrocarbon fraction, boiling range of 150° C. to 210° C.) and heated to 150° C. until the stream of distillate which occurs subsides significantly. This is followed by heating at 190° C. for 6 hours and application at reduced pressure (about 500 mbar) until a total of 108 g of water have separated out.

The resulting product is admixed with benzyl alcohol until the nonvolatiles fraction obtained (2.0±0.1 g test substance, duplicate determination, 20 minutes, 150° C.; EN ISO 3251) is 70-75 wt %.

### Preparation of (b1.2)

400 g of Lupasol P (polyethyleneimine from BASF SE, 50% form) are admixed with 600 g of benzyl alcohol and then freed from the water by distillation at 100° C. under reduced pressure (slow reduction of the pressure from atmospheric pressure to 30 mbar) until distillate is no longer obtained. Then, under an inert gas atmosphere, 200 g of tall oil fatty acid (acid number: 186 mg KOH/g substance) are added and the batch is reacted at 140° C. for three hours.

A pale yellow product having an active substance content of 40% is obtained.

### Preparation of (b1.3)

According to patent specification DE3706860A1, example 8 referred to therein is synthesized. In deviation from the protocol there, dilution takes place not to 50% in cyclohexanone but instead to 50% in solvent naphtha (aromatic hydrocarbon fraction, boiling range of 150° C. to 210° C.)

### Preparation of (b1.4)

800 g of Lupasol P (polyethyleneimine from BASF SE, 50% form) are admixed with 400 g of benzyl alcohol and then freed from the water by distillation at 100° C. under reduced pressure (slow reduction of the pressure from atmospheric pressure to 30 mbar) until distillate is no longer obtained. Then, under an inert gas atmosphere, 200 g of tall oil fatty acid (acid number: 186 mg KOH/g substance) are added and the batch is reacted at 140° C. for three hours.

A pale yellow product having an active substance content of 60% is obtained.

### Preparation of (b1.5)

600 g of Lupasol P (polyethyleneimine from BASF SE, 50% form) are admixed with 300 g of benzyl alcohol and then freed from the water by distillation at 100° C. under reduced pressure (slow reduction of the pressure from atmospheric pressure to 30 mbar) until distillate is no longer obtained. Then, under an inert gas atmosphere, 120 g of tall oil fatty acid (acid number: 186 mg KOH/g substance) are added and the batch is reacted at 140° C. for three hours.

A pale yellow product having an active substance content of 58% is obtained.

### Components (b1.x) Below are Available Commercially:

### Component (b1.6)

Lupasol P, polyethyleneimine from BASF SE, Mw about 750 000 Da (active substance content: 50 wt %)

### Component (b1.7)

Tween 20, polyoxyethylene(20)-sorbitan monolaurate

### Component (b1.8)

Triethylenetetramine

### Component (b1.9)

Isophoronediamine, isomer mixture

### Component (b1.10)

Diglycolamine

### Component (b1.11)

Jeffamine T-403, polyetheramine from Huntsman

### USE EXAMPLES

Described below is the production of inventive two-component systems obtained from in each case two base components by mixing—as indicated below. Unless indicated otherwise, not only the commercial products but also the inorganic thickeners (a1.x), the wetting and dispersing agents (a2.x), and the components (b1.x) are used in the form of the commercial product or synthesis product. The quantities (in g) therefore relate to the respective commercial and synthesis products, including any solvents present and/or including any auxiliaries present as a result of the production process and not removed.

### LIST OF COMMERCIAL PRODUCTS USED IN THE USE EXAMPLES

Palatal P 4: Unsaturated polyester resin based on ortho-phthalic acid and standard glycols, in solution in styrene. From DSM.
Palatal A 400: Unsaturated polyester resin based on isophthalic acid and standard glycols, in solution in styrene. From DSM.
Palatal A 410: Unsaturated polyester resin based on isophthalic acid and neopentyl glycol, in solution in styrene. From DSM.
COR 61-219-655: Unsaturated polyester resin based on DCPD, in solution in styrene. From Interplastic.
MEKP Butanox® M 50: Curing agent based on methyl ethyl ketone peroxide (MEKP), in solution in dimethyl phthalate, from Akzo Nobel.
Accelerator NL-51P: Accelerator based on cobalt(II) 2-ethylhexanoate, 6% Co, in liquid mixture, from Akzo Nobel.
Accelerator NL-49P: Accelerator based on cobalt(II) 2-ethylhexanoate, 1% Co, in liquid mixture, from Akzo Nobel.
BYK®-A 555: Polymer-containing deaerating agent from BYK-Chemie GmbH.
Apyral 1 E: Mineral flame retardant from Nabaltec AG.
TiO₂ paste (50 wt % TiO₂): 50% TiO₂ (RKB2 from Tronox) in Palatal A400 (dispersing conditions: dissolver, 20 minutes, 5000 rpm).
   System with Unsaturated Polyesters

### Preparation of Respective Base Components SK.PA, SK.PC, SK.PE, SK.PG, SK.PI and SK.PK

The individual constituents of the base components SK.PA, SK.PC, SK.PE, SK.PG, SK.PI and SK.PK are mixed in the quantities indicated in tables 1 to 15 with stirring at room temperature (23° C.) using the Pendraulik TD 100 dissolver with a toothed disk at 2 to 5 m/s and then stirred for homogenization for 1 minute at 5 m/s, 1 minute at 10 m/s, and 1 minute at 15 m/s. The viscosity of these systems is subsequently measured at room temperature (23° C.)

### Preparation of the Intermediates by Combination of Base Components SK.PA and SK.PB, SK.PC and SK.PD, SK.PE and SK.PF, SK.PG and SK.PH, SK.PI and SK.PJ, and SK.PK and SK.PL

The base components SK.PB, SK.PD, SK.PF, SK.PH, SK.PJ and SK.PL are added to the respective base components SK.PA, SK.PC, SK.PE, SK.PG, SK.PI and SK.PK and homogenized with the Pendraulik TD 100 dissolver with a toothed disk at 5 m/s for 1 minute. Viscosity is measured after 2 minutes.

TABLE 1
(quantities in g)

| | Comp. ex. VP1 | | Comp. ex. VP2 | |
|---|---|---|---|---|
| Constituents | SK.PA | SK.PB | SK.PA | SK.PB |
| Palatal A400 | 93.56 | | 93.56 | |
| BYK-A 555 | 0.50 | | 0.50 | |
| NL 51 P | 0.99 | | 0.99 | |
| (a1.1) | 4.95 | | 4.95 | |
| (a2.x) | 0.0 | | 0.0 | |
| MEKP Butanox M50 | | 1.0 | | 1.0 |
| (b1.7) | | 0.0 | | 1.0 |

TABLE 2
(quantities in g)

| | Ex. P1 | | Ex. P2 | | Ex. P3 | | Ex. P4 | | Ex. P5 | |
|---|---|---|---|---|---|---|---|---|---|---|
| | SK. | SK. | SK. | SK. | SK. | SK. | SK. | SK. | SK. | SK. |
| Constituents | PA | PB | PA | PB | PA | PB | PA | PB | PA | PB |
| Palatal A | 93.56 | | 93.56 | | 93.56 | | 93.56 | | 93.56 | |
| 400 | | | | | | | | | | |
| BYK-A 555 | 0.50 | | 0.50 | | 0.50 | | 0.50 | | 0.50 | |
| NL 51 P | 0.99 | | 0.99 | | 0.99 | | 0.99 | | 0.99 | |
| (a1.1) | 4.95 | | 4.95 | | 4.95 | | 4.95 | | 4.95 | |
| (a2.x) | 3.5¹ | | 3.5¹ | | 3.5¹ | | 3.5² | | 3.5² | |
| MEKP Butanox | | 1.0 | | 1.0 | | 1.0 | | 1.0 | | 1.0 |
| M50 | | | | | | | | | | |
| (b1.x) | | 0.99* | | 2.97** | | 0.99*** | | 0.99** | | 0.99**** |

¹= (a2.1);
²= (a2.7);
*= (b1.7);
**= (b1.3);
***= (b1.1);
****= (b1.2)

TABLE 3
(quantities in g)

| | Ex. P6 | | Ex. P7 | | Ex. P8 | | Ex. P9 | | Ex. P10 | |
|---|---|---|---|---|---|---|---|---|---|---|
| | SK. | SK. | SK. | SK. | SK. | SK. | SK. | SK. | SK. | SK. |
| Constituents | PA | PB | PA | PB | PA | PB | PA | PB | PA | PB |
| Palatal A | 93.56 | | 93.56 | | 93.56 | | 93.56 | | 93.56 | |
| 400 | | | | | | | | | | |
| BYK-A 555 | 0.50 | | 0.50 | | 0.50 | | 0.50 | | 0.50 | |
| NL 51 P | 0.99 | | 0.99 | | 0.99 | | 0.99 | | 0.99 | |
| (a1.1) | 4.95 | | 4.95 | | 4.95 | | 4.95 | | 4.95 | |
| (a2.9) | 3.5 | | 3.5 | | 3.5 | | 2.0 | | 2.0 | |
| MEKP Butanox | | 1.0 | | 1.0 | | 1.0 | | 1.0 | | 1.0 |
| M50 | | | | | | | | | | |
| (b1.x) | | 0.99* | | 0.99** | | 0.99*** | | 1.98*** | | 2.97*** |

*= (b1.1);
**= (b1.7);
***= (b1.3)

TABLE 4
(quantities in g)

| | Ex. P11 | | Ex. P12 | | Ex. P13 | | Ex. P14 | | Ex. P15 | |
|---|---|---|---|---|---|---|---|---|---|---|
| | SK. | SK. | SK. | SK. | SK. | SK. | SK. | SK. | SK. | SK. |
| Constituents | PC | PD | PC | PD | PC | PD | PC | PD | PC | PD |
| Palatal P4 | 92.65 | | 92.65 | | 92.65 | | 92.65 | | 92.65 | |
| BYK-A 555 | 0.49 | | 0.49 | | 0.49 | | 0.49 | | 0.49 | |
| NL 49 P | 1.96 | | 1.96 | | 1.96 | | 1.96 | | 1.96 | |
| (a1.1) | 4.90 | | 4.90 | | 4.90 | | 4.90 | | 4.90 | |
| (a2.7) | 3.5 | | 3.5 | | 3.5 | | 3.5 | | 3.5 | |
| MEKP Butanox | | 1.5 | | 1.5 | | 1.5 | | 1.5 | | 1.5 |
| M50 | | | | | | | | | | |
| (b1.x) | | 0.98* | | 0.98** | | 0.98*** | | 0.98**** | | 0.98***** |

*= (b1.3);
**= (b1.1);
***= (b1.2);
****= (b1.7);
*****= (b1.10)

TABLE 5
(quantities in g)

| | Ex. P16 | | Ex. P17 | | Ex. P18 | | Ex. P19 | | Ex. P20 | |
|---|---|---|---|---|---|---|---|---|---|---|
| | SK. | SK. | SK. | SK. | SK. | SK. | SK. | SK. | SK. | SK. |
| Constituents | PC | PD | PC | PD | PC | PD | PC | PD | PC | Pd |
| Palatal P4 | 92.65 | | 92.65 | | 92.65 | | 92.65 | | 92.65 | |
| BYK-A 555 | 0.49 | | 0.49 | | 0.49 | | 0.49 | | 0.49 | |
| NL 49 P | 1.96 | | 1.96 | | 1.96 | | 1.96 | | 1.96 | |
| (a1.1) | 4.90 | | 4.90 | | 4.90 | | 4.90 | | 4.90 | |
| (a2.1) | 3.5 | | 3.5 | | 3.5 | | 3.5 | | 3.5 | |
| MEKP Butanox | | 1.5 | | 1.5 | | 1.5 | | 1.5 | | 1.5 |
| M50 | | | | | | | | | | |
| (b1.x) | | 1.0* | | 1.0** | | 1.0*** | | 1.0**** | | 1.0***** |

*= (b1.3);
**= (b1.1);
***= (b1.2);
****= (b1.7);
*****= (b.10)

TABLE 6
(quantities in g)

| | Ex. P21 | | Ex. P22 | | Ex. P23 | | Ex. P24 | | Ex. P25 | |
|---|---|---|---|---|---|---|---|---|---|---|
| | SK. | SK. | SK. | SK. | SK. | SK. | SK. | SK. | SK. | SK. |
| Constituents | PC | PD | PC | PD | PC | PD | PC | PD | PC | Pd |
| Palatal P4 | 92.65 | | 92.65 | | 92.65 | | 92.65 | | 92.65 | |
| BYK-A 555 | 0.49 | | 0.49 | | 0.49 | | 0.49 | | 0.49 | |
| NL 49 P | 1.96 | | 1.96 | | 1.96 | | 1.96 | | 1.96 | |
| (a1.1) | 4.90 | | 4.90 | | 4.90 | | 4.90 | | 4.90 | |
| (a2.9) | 3.5 | | 3.5 | | 3.5 | | 3.5 | | 3.5 | |
| MEKP Butanox | | 1.5 | | 1.5 | | 1.5 | | 1.5 | | 1.5 |
| M50 | | | | | | | | | | |
| (b1.x) | | 1.0* | | 1.0** | | 1.0*** | | 1.0**** | | 1.0***** |

*= (b1.3);
**= (b1.1);
***= (b1.2);
****= (b1.7);
*****= (b1.10)

TABLE 7
(quantities in g)

| | Ex. P26 | | Ex. P27 | |
|---|---|---|---|---|
| Constituents | SK.PC | SK.PD | SK.PC | SK.PD |
| Palatal P4 | 92.65 | | 92.65 | |
| BYK-A 555 | 0.49 | | 0.49 | |
| NL 49 P | 1.96 | | 1.96 | |
| (a1.1) | 4.90 | | 4.90 | |
| (a2.9) | 3.5 | | 3.5 | |
| MEKP Butanox M50 | | 1.5 | | 1.5 |
| (b1.3) | | 1.96 | | 2.94 |

TABLE 8
(quantities in g)

| | Ex. P28 | | Ex. P29 | | Ex. P30 | |
|---|---|---|---|---|---|---|
| | SK. | SK. | SK. | SK. | SK. | SK. |
| Constituents | PE | PF | PE | PF | PE | PF |
| Palatal A410 | 95.45 | | 95.55 | | 95.55 | |
| BYK-A 555 | 0.50 | | 0.50 | | 0.50 | |
| NL 51 P | 0.99 | | 0.99 | | 0.99 | |
| (a1.2) | 2.97 | | 2.97 | | 2.97 | |
| (a2.1) | 2.97 | | 0.59 | | 0.59 | |
| MEKP Butanox | | 1.0 | | 1.0 | | 1.0 |
| M50 | | | | | | |
| (b1.3) | | 0.59 | | 1.19 | | 1.78 |

TABLE 9
(quantities in g)

| | Ex. P31 | | Ex. P32 | | Ex. P33 | |
|---|---|---|---|---|---|---|
| | SK. | SK. | SK. | SK. | SK. | SK. |
| Constituents | PE | PF | PE | PF | PE | PF |
| Palatal A410 | 95.45 | | 95.45 | | 95.45 | |
| BYK-A 555 | 0.50 | | 0.50 | | 0.50 | |
| NL 51 P | 0.99 | | 0.99 | | 0.99 | |
| (a1.2) | 2.97 | | 2.97 | | 2.97 | |
| (a2.x) | 2.97¹ | | 2.97² | | 2.97³ | |
| MEKP Butanox | | 1.0 | | 1.0 | | 1.0 |
| M50 | | | | | | |
| (b1.1) | | 0.59 | | 0.59 | | 0.59 |

¹= (a2.7);
²= (a2.1);
³= (2.9);

TABLE 10
(quantities in g)

| | Ex. P34 | | Ex. P35 | | Ex. P36 | | Ex. P37 | | Ex. P38 | |
|---|---|---|---|---|---|---|---|---|---|---|
| | SK. | SK. | SK. | SK. | SK. | SK. | SK. | SK. | SK. | SK. |
| Constituents | PE | PF | PE | PF | PE | PF | PE | PF | PE | PF |
| Palatal A410 | 95.45 | | 95.45 | | 95.45 | | 95.45 | | 95.45 | |
| BYK-A 555 | 0.50 | | 0.50 | | 0.50 | | 0.50 | | 0.50 | |
| NL 51 P | 0.99 | | 0.99 | | 0.99 | | 0.99 | | 0.99 | |
| (a1.1) | 2.97 | | 2.97 | | 2.97 | | 2.97 | | 2.97 | |
| (a2.x) | 2.97¹ | | 2.97² | | 2.97² | | 0.59³ | | 0.59³ | |
| MEKP Butanox | | 1.0 | | 1.0 | | 1.0 | | 1.0 | | 1.0 |
| M50 | | | | | | | | | | |
| (b1.x) | | 0.59* | | 0.59* | | 0.59** | | 1.19*** | | 2.38*** |

¹= (a2.7);
²= (a2.9);
³= (a2.1);
*= (b1.10);
**= (b1.2);
***= (b1.4)

TABLE 11
(quantities in g)

| | Ex. P39 | | Ex. P40 | |
|---|---|---|---|---|
| Constituents | SK.PG | SK.PH | SK.PG | SK.PH |
| Palatal A400 | 79.75 | | 79.75 | |
| TiO₂ paste | 10.00 | | 10.00 | |
| (50 wt % of TiO₂ | | | | |
| in Palatal A400) | | | | |
| NL 49 P | 1.00 | | 1.00 | |
| Styrene | 8.00 | | 8.00 | |
| (a1.1) | 1.25 | | 1.25 | |
| (a2.7) | 0.88 | | 0.88 | |
| MEKP Butanox M50 | | 1.0 | | 1.0 |
| (b1.x) | | 0.5* | | 0.5** |

*= (b1.1);
**= (b1.2)

TABLE 12
(quantities in g)

| | Ex. P41 | | Ex. P42 | | Ex. P43 | |
|---|---|---|---|---|---|---|
| | SK. | SK. | SK. | SK. | SK. | SK. |
| Constituents | PG | PH | PG | PH | PG | PH |
| Palatal A400 | 79.75 | | 79.75 | | 79.75 | |
| TiO₂ paste | 10.00 | | 10.00 | | 10.00 | |
| (50 wt % of TiO₂ | | | | | | |
| in Palatal | | | | | | |
| A400) | | | | | | |
| NL 49 P | 1.00 | | 1.00 | | 1.00 | |
| Styrene | 8.00 | | 8.00 | | 8.00 | |
| (a1.1) | 1.25 | | 1.25 | | 1.25 | |
| (a2.1) | 0.88 | | 0.88 | | 0.88 | |
| MEKP Butanox | | 1.0 | | 1.0 | | 1.0 |
| M50 | | | | | | |
| (b1.x) | | 0.25* | | 0.25** | | 0.25*** |

*= (b1.3);
**= (b1.1);
***= (b1.2)

TABLE 13
(quantities in g)

| | Ex. P44 | | Ex. P45 | | Ex. P46 | |
|---|---|---|---|---|---|---|
| | SK. | SK. | SK. | SK. | SK. | SK. |
| Constituents | PG | PH | PG | PH | PG | PH |
| Palatal A400 | 79.75 | | 79.75 | | 79.75 | |
| TiO₂ paste | 10.00 | | 10.00 | | 10.00 | |
| (50 wt % of TiO₂ | | | | | | |
| in Palatal A400) | | | | | | |
| NL 49 P | 1.00 | | 1.00 | | 1.00 | |
| Styrene | 8.00 | | 8.00 | | 8.00 | |
| (a1.1) | 1.25 | | 1.25 | | 1.25 | |
| (a2.9) | 0.50 | | 0.50 | | 0.50 | |
| MEKP Butanox M50 | | 1.0 | | 1.0 | | 1.0 |
| (b1.3) | | 0.25 | | 0.50 | | 0.75 |

TABLE 14
(quantities in g)

| | Ex. P47 | | Ex. P48 | |
|---|---|---|---|---|
| Constituents | SK.PI | SK.PJ | SK.PI | SK.PJ |
| COR 61-219-655 | 93.56 | | 93.56 | |
| Byk-A 555 | 0.50 | | 0.50 | |
| NL 51 P | 0.99 | | 0.99 | |
| (a1.1) | 4.95 | | 4.95 | |
| (a2.8) | 2.48 | | 2.48 | |
| MEKP Butanox M50 | | 1.0 | | 1.0 |
| (b1.3) | | 0.99 | | 1.98 |

TABLE 15
(quantities in g)

| | Ex. P49 | | Ex. P50 | |
|---|---|---|---|---|
| Constituents | SK.PK | SK.PL | SK.PK | SK.PL |
| Palatal P4 | 59.31 | | 59.31 | |
| Byk-A 555 | 0.50 | | 0.50 | |
| NL 51 P | 0.99 | | 0.99 | |
| Apyral IE | 29.70 | | 29.70 | |
| Styrene | 8.14 | | 8.14 | |
| (a1.5) | 1.36 | | 1.36 | |
| (a2.6) | 0.95 | | 0.95 | |
| MEKP Butanox M50 | | 1.0 | | 1.0 |
| (b1.3) | | 0.82 | | 0.27 |

TABLE 16

| | Viscosity* | | | | | |
|---|---|---|---|---|---|---|
| | SK.PA | | Viscosity | | Viscosity* | Viscosity |
| Comp. | without | Viscosity* | loss | Viscosity* | SK.PA + | increase¹ |
| ex. | (a2.x) | SK.PA | in % | SK.PB | SK.PB | in % |
| VP1 | 67.3 | ./. | ./. | ./. | 67.3 | ./. |
| VP2 | 67.3 | ./. | ./. | ./. | 170.2 | ./. |
| | Viscosity* | | | | | |
| | SK.PA | | Viscosity | | Viscosity* | Viscosity |
| | without | Viscosity* | loss | Viscosity* | SK.PA + | increase¹ |
| Ex. | (a2.x) | SK.PA | in % | SK.PB | SK.PB | in % |
| P1 | 67.3 | 27.8 | 59 | 1.2 | 46.1 | 69 |
| P2 | 67.3 | 27.8 | 59 | 1.2 | 63.0 | 127 |
| P3 | 67.3 | 27.8 | 59 | 1.2 | 65.4 | 135 |
| P4 | 67.3 | 15.4 | 77 | 1.2 | 15.8 | 3 |
| P5 | 67.3 | 15.4 | 77 | 1.2 | 18.5 | 20 |
| P6 | 67.3 | 4.0 | 94 | 1.2 | 7.6 | 90 |
| P7 | 67.3 | 4.0 | 94 | 1.2 | 7.1 | 78 |
| P8 | 67.3 | 4.0 | 94 | 1.2 | 29.8 | 645 |
| P9 | 67.3 | 28.2 | 58 | 1.2 | 61.5 | 118 |
| P10 | 67.3 | 28.2 | 58 | 1.2 | 116.3 | 312 |
| | Viscosity* | | | | | |
| | SK.PC | | Viscosity | | Viscosity* | Viscosity |
| | without | Viscosity* | loss | Viscosity* | SK.PC + | increase² |
| Ex. | (a2.x) | SK.PC | in % | SK.PD | SK.PD | in % |
| P11 | 54.9 | 5.1 | 91 | 1.2 | 34.0 | 567 |
| P12 | 54.9 | 5.1 | 91 | 1.2 | 9.0 | 76 |
| P13 | 54.9 | 5.1 | 91 | 1.2 | 6.3 | 24 |
| P14 | 54.9 | 5.1 | 91 | 1.2 | 6.0 | 18 |
| P15 | 54.9 | 5.1 | 91 | 1.2 | 9.5 | 86 |
| P16 | 54.9 | 3.3 | 94 | 1.2 | 29.7 | 800 |
| P17 | 54.9 | 3.3 | 94 | 1.2 | 52.3 | 1485 |
| P18 | 54.9 | 3.3 | 94 | 1.2 | 3.9 | 18 |
| P19 | 54.9 | 3.3 | 94 | 1.2 | 3.6 | 9 |
| P20 | 54.9 | 3.3 | 94 | 1.2 | 5.4 | 64 |
| P21 | 54.9 | 7.8 | 86 | 1.2 | 36.0 | 362 |
| P22 | 54.9 | 7.8 | 86 | 1.2 | 75.4 | 867 |
| P23 | 54.9 | 7.8 | 86 | 1.2 | 105.0 | 1246 |
| P24 | 54.9 | 7.8 | 86 | 1.2 | 29.7 | 281 |
| P25 | 54.9 | 7.8 | 86 | 1.2 | 71.1 | 812 |
| P26 | 54.9 | 7.8 | 86 | 1.2 | 66.6 | 754 |
| P27 | 54.9 | 7.8 | 86 | 1.2 | 95.4 | 1123 |
| | Viscosity* | | | | | |
| | SK.PE | | Viscosity | | Viscosity* | Viscosity |
| | without | Viscosity* | loss | Viscosity* | SK.PE + | increase³ |
| Ex. | (a2.x) | SK.PE | in % | SK.PF | SK.PF | in % |
| P28 | 31.7 | 5.7 | 82 | 1.2 | 10.2 | 79 |
| P29 | 31.7 | 4.4 | 86 | 1.2 | 25.8 | 486 |
| P30 | 31.7 | 4.4 | 86 | 1.2 | 48.0 | 991 |
| P31 | 31.7 | 22.5 | 29 | 1.2 | 25.9 | 15 |
| P32 | 31.7 | 5.7 | 82 | 1.2 | 6.9 | 21 |
| P33 | 31.7 | 4.4 | 86 | 1.2 | 7.5 | 70 |
| P34 | 31.7 | 22.5 | 29 | 1.2 | 23.9 | 6 |
| P35 | 31.7 | 4.4 | 86 | 1.2 | 6.6 | 50 |
| P36 | 31.7 | 4.4 | 86 | 1.2 | 4.6 | 5 |
| P37 | 31.7 | 4.4 | 86 | 1.2 | 17.3 | 293 |
| P38 | 31.7 | 4.4 | 86 | 1.2 | 224.0 | 4991 |
| | Viscosity* | | | | | |
| | SK.PG | | Viscosity | | Viscosity* | Viscosity |
| | without | Viscosity* | loss | Viscosity* | SK.PG + | increase⁴ |
| Ex. | (a2.x) | SK.PG | in % | SK.PH | SK.PH | in % |
| P39 | 3.1 | 1.2 | 61 | 1.2 | 2.9 | 142 |
| P40 | 3.1 | 1.2 | 61 | 1.2 | 3.0 | 150 |
| P41 | 3.1 | 1.2 | 61 | 1.2 | 2.4 | 100 |
| P42 | 3.1 | 1.2 | 61 | 1.2 | 4.5 | 275 |
| P43 | 3.1 | 1.2 | 61 | 1.2 | 3.0 | 150 |
| P44 | 3.1 | 1.2 | 61 | 1.2 | 1.6 | 33 |
| P45 | 3.1 | 1.2 | 61 | 1.2 | 2.2 | 83 |
| P46 | 3.1 | 1.2 | 61 | 1.2 | 2.6 | 117 |
| | Viscosity* | | | | | |
| | SK.PI | | Viscosity | | Viscosity* | Viscosity |
| | without | Viscosity* | loss | Viscosity* | SK.PI + | increase⁵ |
| Ex. | (a2.x) | SK.PI | in % | SK.PJ | SK.PJ | in % |
| P47 | 344 | 51.4 | 85 | 1.2 | 62.7 | 22 |
| P48 | 344 | 51.4 | 85 | 1.2 | 81.3 | 58 |
| | Viscosity* | | | | | |
| | SK.PK | | Viscosity | | Viscosity* | Viscosity |
| | without | Viscosity* | loss | Viscosity* | SK.PK + | increase⁶ |
| Ex. | (a2.x) | SK.PK | in % | SK.PL | SK.PL | in % |
| P49 | 3.8 | 2.3** | 39 | 1.2 | 11.0** | 378 |
| P50 | 3.8 | 2.3** | 39 | 1.2 | 11.1** | 383 |

*in pascal-seconds;
**the viscosity was measured at a shear rate of 5 s⁻¹;
¹relative to SK.PA;
²relative to SK.PC;
³relative to SK.PE;
⁴relative to SK.PG;
⁵relative to SK.PI;
⁶relative to SK.PK; base components SK.PC (with a2.x) were stored before mixing with SK.PC for 1 week at room temperature (23° C.)

In comparative example VP1, the base components SK.PA and SK.PB were prepared without the compounds (a2) and (b1). It is found that the viscosity of the thixotroped base component SK.PA is very high and the viscosity when the curing agent (base component SK.PB) is added no longer changes until the system is cured.

In comparative example VP2, the base component SK.PA was prepared without wetting and dispersing agent (a2), and base component SK.PB was prepared with 1.0 g of the polymer (b1) (here: (b1.7)). It is found that the viscosity of the base component SK.PA is very high and the addition of the polymer (b1) increases still further the viscosity of the mixture of base components SK.PA and SK.PB.

In the inventive examples P1 to P50, different two-component systems were prepared from the constituents listed in tables 2 to 11, in the quantities indicated in the tables in each case.

In general there is a significant reduction in the viscosity of the thixotroped base components from the addition of the respective wetting and dispersing agents (a2.x). This makes processing easy and also makes the base components very easy to mix.

Examples which may be emphasized here, on an exemplary basis, are the five series P21 to P25. From the use of the wetting and dispersing additive a2.9, the viscosity of the base component SK.PC is reduced significantly by 86% for all examples. Depending on the structure of the viscosity-increasing compound, the addition of the component (b1) leads to very different results: the relatively smallest effect of the increase in viscosity is obtained by using the OH-functional compounds TWEEN 20 (b1.7, here in the ex. P24) and b1.3 (example 21). The success of these viscosity increases, though already considerable, can be increased still further, nevertheless, through the use of amine-containing compounds. The use of the compounds b1.1 (example P22) and b1.10 (diglycolamine, example P25) raises the viscosity of the mixtures of the two base components significantly again, with the viscosity increase being even higher when using the compound b1.2 in example P23. These results are attributable to the difference in quality of the structural elements with affinity for the thickener surface. The greater the number of ideally suitable functional groups present as structural elements with affinity for the thickener surface, and the more ideal, i.e., the more uniform, these groups are distributed over the structure of the compound b1.x, the greater the suitability as viscosity-boosting compound.

(a1.x)(a2.x)-(b1.x) Combinations without Unsaturated Polyester Constituent

Described below is a simple “preliminary” test for selecting (a1.x) (a2.x)-(b1.x) combinations having potential suitability. For this test (a1.x) and (a2.x) are introduced in a solvent and then (b1.x) is incorporated in pure form or in solution. The thickening effect is ascertained from the increase in viscosity.

### Preparation of the Binder-Free Test Systems

The solvent (PMA=methoxypropyl acetate, benzyl alcohol, styrene or water) and the inorganic thickeners (a1.x) (for amounts see tables) are mixed with the Pendraulik TD 100 dissolver with a toothed disk at 2 m/s and then homogenized by stirring for a further 1 minute at 5 m/s, 1 minute at 10 m/s, and 1 minute at 15 m/s. Subsequently the wetting and dispersing agent (a2.x) (for amounts see tables) is added and homogenization takes place for 1 minute at 10 m/s. After cooling to room temperature (23° C.), a measurement is made of the viscosity of the system SK.MA, SK.MC, SK.ME, SK.MG and SK.MI, respectively. Thereafter the components SK.MB, SK.MD, SK.MF, SK.MH and SK.MJ, respectively, comprising component (b1.x), are added. This is followed by homogenization for 1 minute at 5 m/s and by measurement of the viscosity after 2 minutes (viscosity after incorporation of (b1.x)).

TABLE 17
(quantity figures in g)

| | |
|---|---|
| Comp. ex. M1 | Comp. ex. M2 |

| Constituents | SK.MA | SK.MB | SK.MA | SK.MB |
|---|---|---|---|---|
| PMA | 90.0 | | 90.0 | |
| (a1.1) | 10.0 | | 10.0 | |
| (a2.x) | 0.0 | | 0.0 | |
| Benzyl alcohol | | 0.0 | | 0.0 |
| (b1.1) | | 0.0 | | 2.0 |

TABLE 18
(quantity figures in g)

| | Ex. M1 | | Ex. M2 | | Ex. M3 | | Ex. M4 | | Ex. M5 | |
|---|---|---|---|---|---|---|---|---|---|---|
| | SK. | SK. | SK. | SK. | SK. | SK. | SK. | SK. | SK. | SK. |
| Constituents | MA | MB | MA | MB | MA | MB | MA | MB | MA | MB |
| PMA | 90.0 | | 90.0 | | 90.0 | | 90.0 | | 90.0 | |
| (a1.1) | 10.0 | | 10.0 | | 10.0 | | 10.0 | | 10.0 | |
| (a2.x) | 5.0¹ | | 5.0¹ | | 5.0² | | 5.0² | | 5.0² | |
| Benzyl | | 0.0 | | 0.0 | | 0.0 | | 98.0 | | 98.0 |
| alcohol | | | | | | | | | | |
| (b1.x) | | 2.0* | | 1.0** | | 1.0*** | | 2.0* | | 2.0** |

¹= (a2.1);
²= (a2.4);
*= (b1.1);
**= (b1.2);
***(b1.3)

TABLE 19
(quantity figures in g)

| | |
|---|---|
| Ex. M6 | Ex. M7 |

| Constituents | SK.MA | SK.MB | SK.MA | SK.MB |
|---|---|---|---|---|
| PMA | 90.0 | | 90.0 | |
| (a1.1) | 10.0 | | 10.0 | |
| (a2.5) | 5.0 | | 5.0 | |
| Benzyl alcohol | | 98.0 | | 98.0 |
| (b1.x) | | 2.0* | | 2.0** |

*= (b1.1);
**= (b1.2)

TABLE 20
(quantity figures in g)

| | Ex. M8 | | Ex. M9 | | Ex. M10 | |
|---|---|---|---|---|---|---|
| Constituents | SK.MC | SK.MD | SK.MC | SK.MD | SK.MC | SK.MD |
| PMA | 87.0 | | 87.0 | | 87.0 | |
| (a1.4) | 13.0 | | 13.0 | | 13.0 | |
| (a2.1) | 5.2 | | 5.2 | | 5.2 | |
| (b1.x) | | 2.6* | | 1.95** | | 1.3*** |

*= (b1.3);
**= (b1.1);
***= (b1.2)

TABLE 21
(quantity figures in g)

| | Ex. M11 | | Ex. M12 | | Ex. M13 | |
|---|---|---|---|---|---|---|
| Constituents | SK.MC | SK.MD | SK.MC | SK.MD | SK.MC | SK.MD |
| PMA | 87.0 | | 87.0 | | 87.0 | |
| (a1.4) | 13.0 | | 13.0 | | 13.0 | |
| (a2.4) | 5.2 | | 5.2 | | 5.2 | |
| (b1.x) | | 2.6* | | 1.95** | | 1.3*** |

*= (b1.3);
**= (b1.1);
***= (b1.2)

TABLE 22
(quantity figures in g)

| | Ex. M14 | | Ex. M15 | | Ex. M16 | |
|---|---|---|---|---|---|---|
| Constituents | SK.MC | SK.MD | SK.MC | SK.MD | SK.MC | SK.MD |
| PMA | 87.0 | | 87.0 | | 87.0 | |
| (a1.4) | 13.0 | | 13.0 | | 13.0 | |
| (a2.9) | 5.2 | | 5.2 | | 5.2 | |
| (b1.x) | | 2.6* | | 1.95** | | 1.3*** |

*= (b1.3);
**= (b1.1);
***= (b1.2)

TABLE 23
(quantity figures in g)

| | Ex. M17 | | Ex. M18 | | Ex. M19 | |
|---|---|---|---|---|---|---|
| Constituents | SK.ME | SK.MF | SK.ME | SK.MF | SK.ME | SK.MF |
| PMA | 85.0 | | 85.0 | | 85.0 | |
| (a1.3) | 15.0 | | 15.0 | | 15.0 | |
| (a2.1) | 6.0 | | 6.0 | | 6.0 | |
| (b1.x) | | 3.0* | | 2.25** | | 1.5*** |

*= (b1.3);
**= (b1.1);
***= (b1.2)

TABLE 24
(quantity figures in g)

| | Ex. M20 | | Ex. M21 | | Ex. M22 | |
|---|---|---|---|---|---|---|
| Constituents | SK.ME | SK.MF | SK.ME | SK.MF | SK.ME | SK.MF |
| PMA | 85.0 | | 85.0 | | 85.0 | |
| (a1.3) | 15.0 | | 15.0 | | 15.0 | |
| (a2.3) | 6.0 | | 6.0 | | 6.0 | |
| Benzyl | | 0.0 | | 0.0 | | 98.5 |
| alcohol | | | | | | |
| (b1.x) | | 3.0* | | 2.25** | | 1.5*** |

*= (b1.3);
**= (b1.1);
***= (b1.2)

TABLE 25
(quantity figures in g)

| | Ex. M23 | | Ex. M24 | | Ex. M25 | |
|---|---|---|---|---|---|---|
| Constituents | SK.ME | SK.MF | SK.ME | SK.MF | SK.ME | SK.MF |
| PMA | 85.0 | | 85.0 | | 85.0 | |
| (a1.3) | 15.0 | | 15.0 | | 15.0 | |
| (a2.8) | 6.0 | | 6.0 | | 6.0 | |
| Benzyl | | 0.0 | | 0.0 | | 98.5 |
| alcohol | | | | | | |
| (b1.x) | | 3.0* | | 2.25** | | 1.5*** |

*= (b1.3);
**= (b1.1);
***= (b1.2)

TABLE 26
(quantity figures in g)

| | Ex. M26 | | Ex. M27 | | Ex. M28 | |
|---|---|---|---|---|---|---|
| Constituents | SK.MG | SK.MH | SK.MG | SK.MH | SK.MG | SK.MH |
| Styrene | 85.0 | | 85.0 | | 85.0 | |
| (a1.5) | 15.0 | | 15.0 | | 15.0 | |
| (a2.12) | 6.0 | | 6.0 | | 6.0 | |
| (b1.x) | | 3.0* | | 3.0** | | 3.0*** |

*= (b1.3);
**= (b1.7);
***= (b1.10)

TABLE 27

| | Ex. M29 | | Ex. M30 | | Ex. M31 | |
|---|---|---|---|---|---|---|
| Constituents | SK.MG | SK.MH | SK.MG | SK.MH | SK.MG | SK.MH |
| Styrene | 85.0 | | 85.0 | | 85.0 | |
| (a1.5) | 15.0 | | 15.0 | | 15.0 | |
| (a2.3) | 6.0 | | 6.0 | | 6.0 | |
| (b1.x) | | 3.0* | | 3.0** | | 3.0*** |

*= (b1.3);
**= (b1.7);
***= (b1.10)

TABLE 28
(quantity figures in g)

| | Ex. M32 | | Ex. M33 | | Ex. M34 | |
|---|---|---|---|---|---|---|
| Constituents | SK.MG | SK.MH | SK.MG | SK.MH | SK.MG | SK.MH |
| Styrene | 85.0 | | 85.0 | | 85.0 | |
| (a1.5) | 15.0 | | 15.0 | | 15.0 | |
| (a2.9) | 6.0 | | 6.0 | | 6.0 | |
| (b1.x) | | 3.0* | | 3.0** | | 3.0*** |

*= (b1.3);
**= (b1.7);
***= (b1.10)

TABLE 29
(quantity figures in g)

| | |
|---|---|
| Ex. M35 | Ex. M36 |

| Constituents | SK.MI | SK.MJ | SK.MI | SK.MJ |
|---|---|---|---|---|
| Water | 85.0 | | 85.0 | |
| (a1.5) | 15.0 | | 15.0 | |
| (a2.1) | 6.0 | | 6.0 | |
| (b1.6) | | 0.75 | | 3.0 |

TABLE 30

| | Viscosity* | | | | | |
|---|---|---|---|---|---|---|
| | SK.MA | | Viscosity | | Viscosity* | Viscosity |
| Comp. | without | Viscosity* | loss | Viscosity* | SK.MA + | increase¹ |
| ex. | (a2.x) | SK.MA | in % | SK.MB | SK.MB | in % |
| VM1 | 16.7 | ./. | ./. | ./. | ./. | ./. |
| VM2 | 16.7 | ./. | ./. | ./. | 54.8 | ./. |
| | Viscosity* | | | | | |
| | SK.MA | | Viscosity | | Viscosity* | Viscosity |
| | without | Viscosity* | loss | Viscosity* | SK.MA + | increase¹ |
| Ex. | (a2.x) | SK.MA | in % | SK.MB | SK.MB | in % |
| M1 | 16.7 | 0.44 | 97 | 0.3 | 51.0 | 10491 |
| M2 | 16.7 | 0.44 | 97 | 0.3 | 46.4 | 10445 |
| M3 | 16.7 | 0.19 | 99 | 0.3 | 1.8 | 847 |
| M4 | 16.7 | 0.19 | 99 | 0.01 | 8.9 | 4584 |
| M5 | 16.7 | 0.19 | 99 | 0.01 | 31.5 | 16479 |
| M6 | 16.7 | 1.18 | 93 | 0.01 | 30.6 | 2493 |
| M7 | 16.7 | 1.18 | 93 | 0.01 | 29.2 | 2375 |
| | Viscosity* | | | | | |
| | SK.MC | | Viscosity | | Viscosity* | Viscosity |
| | without | Viscosity* | loss | Viscosity* | SK.MC + | increase² |
| Ex. | (a2.x) | SK.MC | in % | SK.MD | SK.MD | in % |
| M8 | 162 | 10.8 | 93 | 0.3 | 98.7 | 814 |
| M9 | 162 | 10.8 | 93 | 0.3 | 184.1 | 1605 |
| M10 | 162 | 10.8 | 93 | 0.3 | 48.1 | 345 |
| M11 | 162 | 15.7 | 90 | 0.3 | 100.7 | 541 |
| M12 | 162 | 15.7 | 90 | 0.3 | 130.5 | 731 |
| M13 | 162 | 15.7 | 90 | 0.3 | 58.1 | 270 |
| M14 | 162 | 35.1 | 78 | 0.3 | 475.6 | 1255 |
| M15 | 162 | 35.1 | 78 | 0.3 | 488.2 | 1291 |
| M16 | 162 | 35.1 | 78 | 0.3 | 108.9 | 210 |
| | Viscosity* | | | | | |
| | SK.ME | | Viscosity | | Viscosity* | Viscosity |
| | without | Viscosity* | loss | Viscosity* | SK.ME + | increase³ |
| Ex. | (a2.x) | SK.ME | in % | SK.MF | SK.MF | in % |
| M17 | 15.1 | 6.7 | 96 | 0.3 | 45.0 | 572 |
| M18 | 15.1 | 6.7 | 96 | 0.3 | 319.2 | 4664 |
| M19 | 15.1 | 6.7 | 96 | 0.3 | 168.0 | 2407 |
| M20 | 15.1 | 35.3 | 80 | 0.3 | 200.3 | 467 |
| M21 | 15.1 | 35.3 | 80 | 0.3 | 754.3 | 2037 |
| M22 | 15.1 | 35.3 | 80 | 0.01 | 419.9 | 1090 |
| M23 | 15.1 | 4.3 | 98 | 0.3 | 5.1 | 19 |
| M24 | 15.1 | 4.3 | 98 | 0.3 | 21.4 | 398 |
| M25 | 15.1 | 4.3 | 98 | 0.01 | 113.5 | 2540 |
| | Viscosity* | | | | | |
| | SK.MG | | Viscosity | | Viscosity* | Viscosity |
| | without | Viscosity* | loss | Viscosity* | SK.MG + | increase⁴ |
| Ex. | (a2.x) | SK.MG | in % | SK.MH | SK.MH | in % |
| M26 | 30.8 | 16.7 | 46 | 0.3 | 163.4 | 878 |
| M27 | 30.8 | 16.7 | 46 | 0.3 | 68.4 | 310 |
| M28 | 30.8 | 16.7 | 46 | 0.3 | 516.6 | 2993 |
| M29 | 30.8 | 1.0 | 97 | 0.3 | 179.3 | 17830 |
| M30 | 30.8 | 1.0 | 97 | 0.3 | 18.5 | 1750 |
| M31 | 30.8 | 1.0 | 97 | 0.3 | 301.8 | 30080 |
| M32 | 30.8 | 8.1 | 74 | 0.3 | 942.1 | 11 531 |
| M33 | 30.8 | 8.1 | 74 | 0.3 | 603.3 | 7348 |
| M34 | 30.8 | 8.1 | 74 | 0.3 | 1037.0 | 12 702 |
| | Viscosity* | | | | | |
| | SK.MI | | Viscosity | | Viscosity* | Viscosity |
| | without | Viscosity* | loss | Viscosity* | SK.MI + | increase⁵ |
| Ex. | (a2.x) | SK.MI | in % | SK.MJ | SK.MJ | in % |
| M35 | 442 | 22.1 | 95 | 1.8 | 34.4 | 56 |
| M36 | 442 | 22.1 | 95 | 1.8 | 217.7 | 885 |

*in pascal-seconds;
¹relative to SK.MA;
²relative to SK.MC;
³relative to SK.ME;
⁴relative to SK.MG;
⁵relative to SK.MI

Particularly meaningful are the examples of the three series M26 to M28, M29 to M31 and M32 to M34 for UP systems, since they were carried out with different styrene-containing (a1.5)/(a2.x) combinations (module 1) and with components (b1.3), (b1.7) and (b.10), respectively (module 2). In each of the three experimental series, the component (b1.10) gave the best viscosity-boosting effect, and component (b1.7) the poorest. Diglycolamine (=b1.10) here possesses the highest fraction of structural elements with affinity for the thickener surface, including an amino group and a hydroxyl group, whereas TWEEN 20 (=b1.7) possesses exclusively hydroxyl groups as structural elements with affinity for the thickener surface, in a much lower proportion.

The strongest effects are recorded in accordance with the invention for examples M29 to M31, being equipped by the wetting and dispersing agent (a2.3) with the lowest proportion of structural elements having affinity for the thickener surface among the dispersants (a2.12), (a2.3) and (a2.9) compared in the styrene-based systems.

1. A two-component Two or multicomponent system comprising at least one polyester component 1 which comprises
i. at least one unsaturated polyester,
ii. at least one ethylenically unsaturated monomer,
iii. at least one inorganic thickener (a1), and
iv. at least one wetting and dispersing agent (a2) which inhibits the thickening effect of the inorganic thickener (a1);
and
at least one initiator component 2 which comprises
i. at least one component (b1) which is able at least partly to eliminate the inhibition of the thickening effect of the inorganic thickener (a1), and
ii. at least one initiator which is able to trigger the polymerization of components i. and ii. of the polyester component 1; and
the wetting and dispersing agent (a2) being nonreactive toward components i. and ii. of the polyester component 1.

2. The two-component or multicomponent system as claimed in claim 1, the inorganic thickener (a1) being selected from the group consisting of phyllosilicates, precipitated silicas, and fumed silicas.

3. The two-component or multicomponent system as claimed in claim 1, the inorganic thickener (a1) being non-organically modified fumed silica or hydrophobically modified fumed silica.

4. The two-component Two or multicomponent system as claimed in claim 1, the inorganic thickener (a1) being a phyllosilicate mixture which has been surface-treated with quaternary alkylammonium salts and which comprises 50 to 95 wt %, based on the phyllosilicate mixture, of a clay mineral selected from the group consisting of sepiolite and palygorskite or mixtures thereof and less than 50 wt %, based on the phyllosilicate mixture, of at least one smectite.

5. The two-component or multicomponent system as claimed in claim 1, the unsaturated polyester of the polyester component 1 being obtained by reaction between
at least one unsaturated dicarboxylic acid selected from the group acid, fumaric acid, mesaconic acid, citraconic acid, and itaconic acid and anhydrides thereof, and also
optionally using at least one further dicarboxylic acid selected from aliphatic, cycloaliphatic, and aromatic dicarboxylic acids;
and
at least one diol selected from the group 1,2-propanediol, 1,3-propanediol, ethylene glycol, diethylene glycol, dipropylene glycol, triethylene glycol, neopentyl glycol, 2-methyl-2-ethylpropane-1,3-diol, hydrogenated bisphenol A, and oxalkylated bisphenols, and also, optionally,
an alcohol selected from the group monoallyl and diallyl ethers of glycerol, monoallyl and diallyl ethers of trimethylolpropane, and diallyl and triallyl ethers of pentaerythritol.

6. The two-component or multicomponent system as claimed in claim 1, the polyester component 1 comprising as ethylenically unsaturated monomer at least one selected from the group consisting of styrene, alpha-methylstyrene, methyl acrylate, methyl methacrylate, vinyl acetate, divinylbenzene, diallyl phthalate, triallyl cyanurate, and triallyl phosphate.

7. The two-component or multicomponent system as claimed in claim 1, the polyester component 1 further comprising
v. at least one accelerator selected from the group of heavy metal salts or tertiary aromatic amines.

8. The two-component Two or multicomponent system as claimed in claim 1, the initiator component 2 comprising as initiator an initiator selected from the group consisting of hydroperoxides, peroxides, and photoinitiators, and, in the case of the hydroperoxides and peroxides, there being an accelerator in the polyester component 1 selected from the group of heavy metal salts or tertiary aromatic amines.

9. The two-component or multicomponent system as claimed in claim 1, the wetting and dispersing agent (a2) and the component (b1) being selected such that they comprise one or more of the following functional groups selected from
group 1: consisting of
imidazolyl groups, with the structural element N—C═N,
amino groups with the structural elements N for tertiary amines, NH for secondary amines, and NH₂ for primary amines, and
ammonium groups with the structural element NH⁺X⁻ for ammonium salts of tertiary amines, with the structural element NH₂⁺X⁻ for ammonium salts of secondary amines, and NH₃⁺X⁻ for ammonium salts of primary amines, X⁻ in each case being the anion of an acid;
and/or
group 2: consisting of
hydroxyl groups with the structural element OH,
urea groups with the structural element HNC(O)CNH for ureas of primary amines and NC(O)CN for ureas of secondary amines,
amide groups, with the structural element C(O)N for amides of secondary amines, C(O)NH for amides of primary amines, and C(O)NH₂ for amides of ammonia,
carboxylic acid groups with the structural element COOH, and
organic phosphoric ester groups with the structural element OP(O)(OH)₂, and
(A) the weight percentage fraction of structural elements in the wetting and dispersing agent (a2), selected from the functional groups of groups 1 and 2, based on the weight of the wetting and dispersing agent (a2), being lower than the weight percentage fraction of structural elements in component (b1), selected from the functional groups of groups 1 and 2, based on the weight of the component (b1);
and/or
(B) component (b1) comprising a higher weight percentage fraction of structural elements from the functional groups selected from group 1, based on the weight of component (b1), than that of the structural elements from the functional groups selected from group 1 in the wetting and dispersing agent (a2), based on the weight of the wetting and dispersing agent (a2).

10. The two-component or multicomponent system as claimed in claim 9,
(A) the weight percentage fraction of structural elements selected from the functional groups of groups 1 and 2, based on the weight of the wetting and dispersing agent (a2), being less than 11 wt %, and
the weight percentage fraction of structural elements selected from the functional groups of groups 1 and 2, based on the weight of component (b 1), being greater than or equal to 11 wt %.

11. The two-component or multicomponent system as claimed in claim 9, the difference in the weight percentage fractions of structural elements between the wetting and dispersing agent (a2) and component (b1) being at least 2 wt %.

12. The two-component Two or multicomponent system as claimed in claim 1, the weight ratio of wetting and dispersing agent (a2) to component (b1) being 15:1 to 1:5.

13. The two-component or multicomponent system as claimed in claim 1, the wetting and dispersing agent (a2) binding reversibly to the surface of the inorganic thickener (a1).

14. The two-component or multicomponent system as claimed in claim 1, the polymer (b1) being able to bind to the surface of the inorganic thickener (a1) with at least partial displacement of (a2).

15. The two-component Two or multicomponent system as claimed in claim 1, being an adhesive, sealant, a coating material or a molding compound.

16. A substrate coated with a two-component or multicomponent system of claim 1.

17. A method comprising utilizing at least one inorganic thickener (a1) and at least one wetting and dispersing agent (a2) which inhibits the thickening effect of the inorganic thickener (a1) in a formulation comprising at least one unsaturated polyester, and providing the formulation with a latent thickening effect.
